(19) United States
(12) Patent Application Publication
(10) Pub. No.: US 2025/0323690 A1
(43) Pub. Date: Oct. 16, 2025

(54) CHANNEL ESTIMATION FOR TRANSMISSIONS USING RECONFIGURABLE INTELLIGENT SURFACES

(71) Applicant: Apple Inc., Cupertino, CA (US)

(72) Inventors: Wanlu Sun, San Diego, CA (US); Boqiang Fan, San Diego, CA (US); Hyukjin Chae, San Diego, CA (US); Mithat C. Dogan, San Jose, CA (US); Sharad Sambhwani, San Diego, CA (US)

(73) Assignee: Apple Inc., Cupertino, CA (US)

(21) Appl. No.: 19/023,047

(22) Filed: Jan. 15, 2025

Related U.S. Application Data
(60) Provisional application No. 63/634,392, filed on Apr. 15, 2024.

(51) Int. Cl. H04B 7/04; H04L 25/02

(52) U.S. Cl. CPC H04B 7/04013; H04L 25/0226

(57) ABSTRACT

The present application relates to devices and components including apparatus, systems, and methods for channel estimations using reconfigurable intelligence services.

### CROSS-REFERENCE TO RELATED APPLICATION

This application claims the benefit of U.S. Provisional Patent Application No. 63/634,392, filed on Apr. 15, 2024, which is herein incorporated by reference in its entirety for all purposes.

### TECHNICAL FIELD

This application relates generally to communication networks and, in particular, to technologies for channel estimation for transmissions using reconfigurable intelligent surfaces.

### BACKGROUND

Reconfigurable intelligent surfaces (RISs) may be used to improve characteristics of a propagation environment for link level performance, which may be especially useful for higher frequency bands such as, for example, millimeter wave or some terahertz bands. An RIS may have an array of antenna elements with individually controllable phase shifters to redirect (for example, reflect/refract) incident waves to a particular direction at a specific center frequency in a programmable fashion. In operation, the relative phase difference across RIS antenna elements may be controlled to point to a particular direction. The RIS coefficients used antenna elements may be quite crude (for example, +1, −1, +j, −j) considering practical quantization bits of phase shifters.

### BRIEF DESCRIPTION OF THE DRAWINGS

FIG. 1 illustrates a network environment in accordance with some embodiments.

FIG. 2 illustrates the network environment in accordance with some additional embodiments.

FIG. 3 illustrates separate channel estimations in accordance with some embodiments.

FIG. 4 is a graph depicting auto-correlation of a single sequence in accordance with some embodiments.

FIG. 5 is a graph depicting cross-correlation between two sequences in accordance with some embodiments.

FIG. 6 illustrates a signaling diagram in accordance with some embodiments.

FIG. 7 illustrates a diagram depicting path delay in accordance with some embodiments.

FIG. 8 illustrates the network environment in accordance with some additional embodiments.

FIG. 9 illustrates a reference signal sequence in accordance with some embodiments.

FIG. 10 illustrates the network environment in accordance with some additional embodiments.

FIG. 11 illustrates a timing diagram in accordance with some embodiments.

FIG. 12 illustrates the network environment in accordance with some additional embodiments.

FIG. 13 illustrates reference signals in accordance with some embodiments.

FIG. 14 illustrates reference signals in accordance with some embodiments.

FIG. 15 illustrates a signal format in accordance with some embodiments.

FIG. 16 illustrates the network environment in accordance with some additional embodiments.

FIG. 17 illustrates separate channel estimations in accordance with some embodiments.

FIG. 18 illustrates reference signal sequences in accordance with some embodiments.

FIG. 19 illustrates the network environment in accordance with some additional embodiments.

FIG. 20 illustrates separate channel estimations in accordance with some embodiments.

FIG. 21 is a diagram using phase-time array architecture for channel estimation in accordance with some embodiments.

FIG. 22 is a diagram using group delay for channel estimation in accordance with some embodiments.

FIG. 23 illustrates an operation flow/algorithmic structure in accordance with some embodiments.

FIG. 24 illustrates another operation flow/algorithmic structure in accordance with some embodiments.

FIG. 25 illustrates timing diagrams in accordance with some embodiments.

FIG. 26 illustrates signaling depicting a group delay application procedure in accordance with some embodiments.

FIG. 27 illustrates another operation flow/algorithmic structure in accordance with some embodiments.

FIG. 28 illustrates an operation flow/algorithmic structure in accordance with some embodiments.

FIG. 29 illustrates another operation flow/algorithmic structure in accordance with some embodiments.

FIG. 30 illustrates a device in accordance with some embodiments.

FIG. 31 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

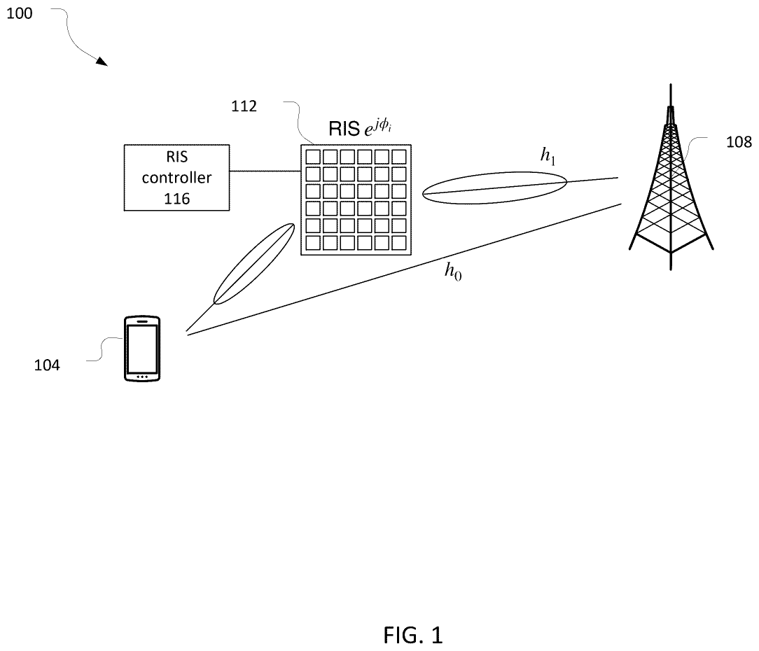

FIG. 1 illustrates a network environment 100 in accordance with some embodiments. The network environment 100 may include a user equipment (UE) 104 communicatively coupled with a base station 108 of a radio access network (RAN). The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

The network environment 100 may further include a RIS 112. The RIS 112 may be used to receive a transmission from the UE 104 and redirect the transmission to the base station 108 and vice versa. A RIS controller 116 may be coupled with the RIS 112 to control phase shifts provided by individual RIS elements in a manner to redirect transmissions as desired. In some embodiments, the RIS controller 116 may be controlled by, or incorporated within, the base station 108 or RAN. In other embodiments, the RIS controller 116 may be controlled by, or incorporated within the UE 104.

The RIS 112 may adjust individual elements to redirect electromagnetic waves in a desired direction. The redirection may be adjusted by changing electric/magnetic properties of a surface to control various characteristics of a signal including, for example, reflection, refraction, absorption, focusing, or polarization. While some embodiments describe the RIS 112 as including an array of passive antenna elements, in other embodiments, the RIS 112 may include an array of controllable microsurface elements. Hereinafter, an element of the RIS 112 may be an antenna element or a microsurface element. Further, because the individual elements may provide individual phase shifts, the elements may also be referred to as phase shifters. The RIS 112 may be a relatively passive component without employing complex radio-frequency chains needed for (de)modulation or amplification.

A direct link between the UE 104 and the base station 108 may be associated with channel h₀ and an indirect link between the UE 104 and the base station 108 via the RIS 112 may be associated with a cascaded UE-RIS-BS channel referred to as h₁. The RIS may have K elements and the phase shifter values for the i^{th} (i∈{1, 2, . . . , K}) RIS element may be defined as ϕᵢ. The effects of ϕᵢ may be included in the cascaded UE-RIS-BS channel, h₁. The reference signal (RS) sent from the UE 104 may be received by the BS 108 over the composite channel h₀+h₁, which may need to be estimated. Further, in some scenarios, it may be beneficial to estimate h₀ and h₁ separately. The disclosure provides various scenarios that benefit from the separated estimations of h₀ and h₁.

In some instances, the channels h₀ and h₁ may be frequency dependent (for example, h₀(f) and h₁(f)) due to, for example, beam squinting. The frequency component, f, is dropped in description of various embodiments for ease of explanation. Nevertheless, the embodiments described herein may also be extended to frequency dependent h₀(f) and h₁(f) channels.

A first scenario that may benefit from separated estimations of h₀ and h₁ may be closed-loop precoding. In some instances, the RIS 112 may be considered as an additional set of antennas for the UE 104 and closed-loop precoding may be applied to uplink transmissions. For example, even if the UE 104 only has a single transmit (Tx) antenna port, the RIS 112 can introduce an additional antenna port for the UE 104. In this way, an appropriate selection of 2-by-1 precoder can efficiently improve uplink transmissions.

Assume, for example, that RIS phase shifters are initially configured as <p for i∈{1, 2, . . . , K} during an RIS beam management process. When the UE-BS channel h₀ and the UE-RIS-BS channel h₁ are not measured separately, signals via these two paths may experience destructive combination at a receiver. Failing to account for a wavelength worth of path difference change may yield destructive combining. However, with the knowledge of h₀ and h₁, the RIS controller 116 can further tune the phase shifters e^{jϕi} for i∈{1, 2, . . . , K} so that the phases of signals via these two paths are aligned at the receiver. As long as the relative phase differences across the K elements are kept the same, the beam direction formed at the RIS 112 will not change.

Providing the BS 108 with the ability to separately estimate h₀ and h₁ may allow the BS 108 to select the appropriate precoder, which may enable efficient UL closed-loop precoding.

A second scenario that may benefit from separated estimations of h₀ and h₁ may be with respect to separate channel quality indicator (CQI) estimation. In some situations, it is beneficial to perform joint RIS selection and CQI calculation. In this case, separate estimations of h₀ and h₁ will enable simultaneously calculation of CQIs for: direct link only (using h₀), RIS link only (using h₁), and combined link (using h₀+h₁). Then, together with selecting the RIS 112 (or not), the corresponding CQI can also be provided.

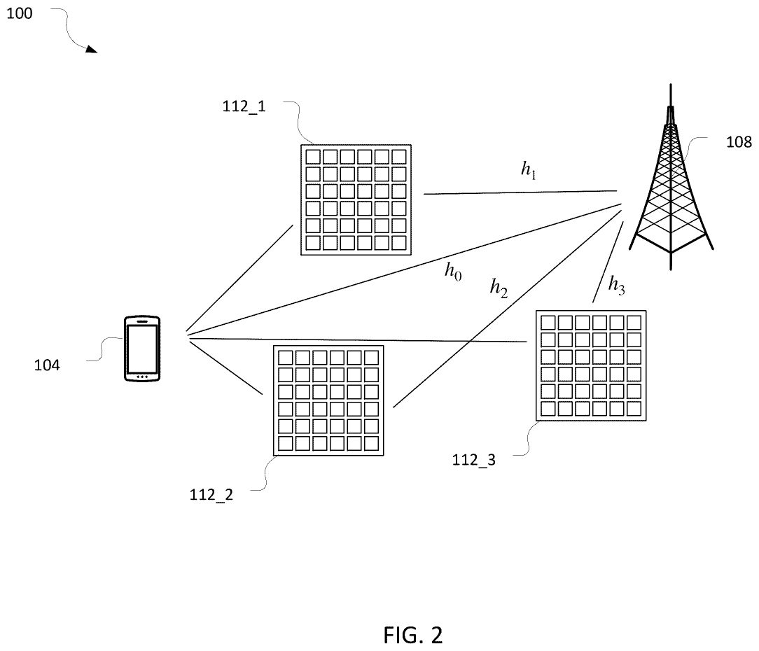

A third scenario that may benefit from separated channel estimations may be with respect to multi-RIS selection. FIG. 2 illustrates the network environment 100 in accordance with some additional embodiments.

In FIG. 2, the network environment 100 may include a plurality of RISs, for example, RIS 112_1, RIS 112_2, and 112_3, with each redirecting a transmission from the UE 104 to the base station 108 or vice versa. The redirected transmissions from RIS 112_1 may be associated with channel h₁, the redirected transmissions from RIS 112_2 may be associated with channel h₂, and the redirected transmissions from RIS 112_3 may be associated with channel h₃.

With the ability to simultaneously select each RIS 112, it may be important that the selected RIS paths constructively combine at the receiver. However, measuring composite channels for arbitrary grouping of the RISs 112 will be very time consuming. Thus, enabling separate channel estimations of each RIS path may simplify the UE/BS calculations of the composite channels and reduce overhead.

A fourth scenario that may benefit from separated estimations of h₀ and h₁ may be with respect to RIS-assisted positioning. For example, RIS 112_1 and RIS 1123 may be used to provide alternative line-of-sight (LOS) paths between the BS 108 and the UE 104 for positioning services. When the delay of BS-RIS-UE paths and the BS-UE path can be separately estimated, the UE 104 can be located using trilateration. The distance between the UE 104 and the BS 108 or a RIS 112 can be calculated if the locations of the BS 108 and the RISs 112 are available.

Embodiments of the present disclosure describe how to separately estimate channel h₀ of the direct UE-BS/BS-UE link and channel h₁ of the cascaded UE-RIS-BS/BS-RIS-UE link in an efficient manner, which may be used in various RIS-assisted transmissions.

In some instances, h₀ and h₁ may be separately estimated by sending a first RS sequence (\tilde{s}₀) when the RIS 112 is turned off and sending a second RS sequence (\tilde{s}₁) when the RIS 112 is turned on. In this way, the receiver can estimate channels as \tilde{h}₀ using \tilde{s}₀ during an off state of the RIS 112, and as \tilde{h}₁ using \tilde{s}₁ during an on state of the RIS 112. The receiver may then derive the channel estimates for the direct link as h₀=\tilde{h}₀, and for the cascaded UE-RIS-BS link as h₁=\tilde{h}₁−\tilde{h}₀. While this may be effective, it may also lead to either higher RS overhead due to the doubled RS resources or lower RS received energy due to the shorten duration per RS resource.

In some instances, h₀ and h₁ may be separately estimated by sending a first RS sequence (\tilde{s}₀) to the BS 108 while the BS 108 uses a beam pointed to the UE 104 and sending a second RS sequence (\tilde{s}₁) to the BS 108 while the BS 108 uses a beam pointed to the RIS 112. In this way, the receiver can estimate h₀ and h₁ using \tilde{s}₀ and \tilde{s}₁ respectively. While this may also be effective, it may be associated with similar challenges described above with respect to turning the RIS 112 on-and-off (for example, it may lead to either higher RS overhead due to the doubled RS resources or lower RS received energy due to the shorten duration per RS resource.)

Embodiments provide for separately estimating the direct UE-BS/BS-UE channel and the cascaded UE-RIS-BS/BS-RIS-UE channel for RIS-assisted transmissions. This may be done in accordance with one or more of the following options. In a first option, the separate estimations may be obtained by RS orthogonalization in code domain via changing RIS phase shifters. In a second option, the separate estimations may be obtained by RS orthogonalization in frequency domain via frequency modulation at the RIS 112. In a third option, separate estimations may be obtained using simultaneous beams. In a fourth option, separate estimations may be obtained via a RIS group delay.

The first option may be desired in some instances as the second and fourth options may generally be associated with a more advanced RIS architecture; and the third option may be associated with more sophisticated implementation at the BS 108.

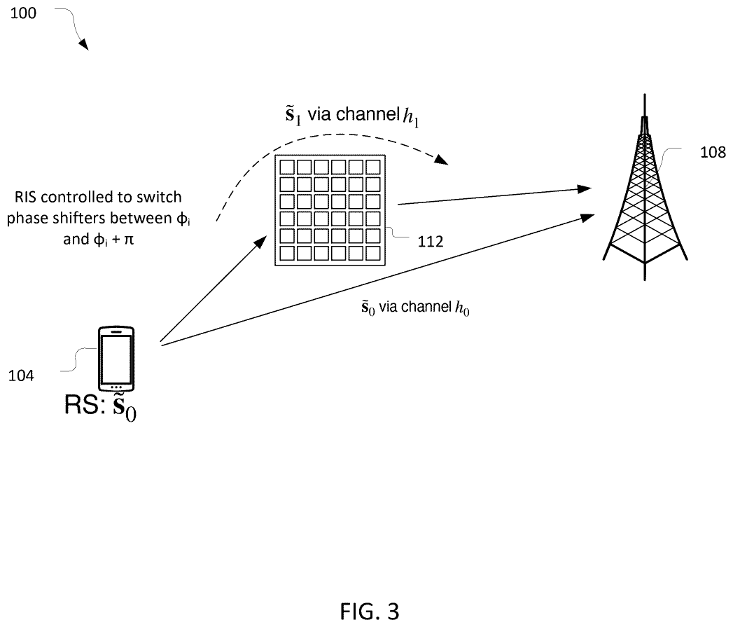

FIG. 3 illustrates separate channel estimations of the first option in the network environment 100 in accordance with some embodiments. The UE 104 may transmit an RS sequence (\tilde{s}₀). This may be provided to the BS 108 via channel h₀. Within the transmission of RS sequence \tilde{s}₀, the RIS 112 may be controlled (by RIS controller 116) to switch the phase shifters between ϕᵢ and ϕᵢ+π so that the effective RS sequence \tilde{s}₁ provided to the base station 108 via channel h₁. The RS sequences \tilde{s}₀ and \tilde{s}₁ may have zero cross-correlation within a certain time zone. This may enable the separate estimations of channels h₀ and h₁ by the receiver of the base station 108.

A zero-correlation zone may be used to characterize a correlation property between RS sequences \tilde{s}₀ and \tilde{s}₁ that permits the separate channel estimations described herein.

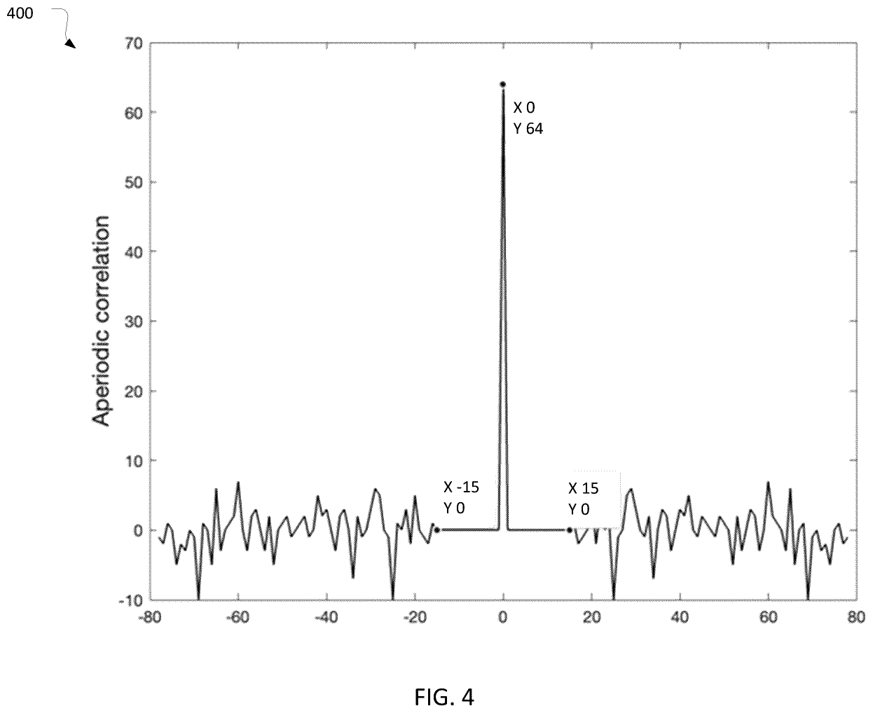

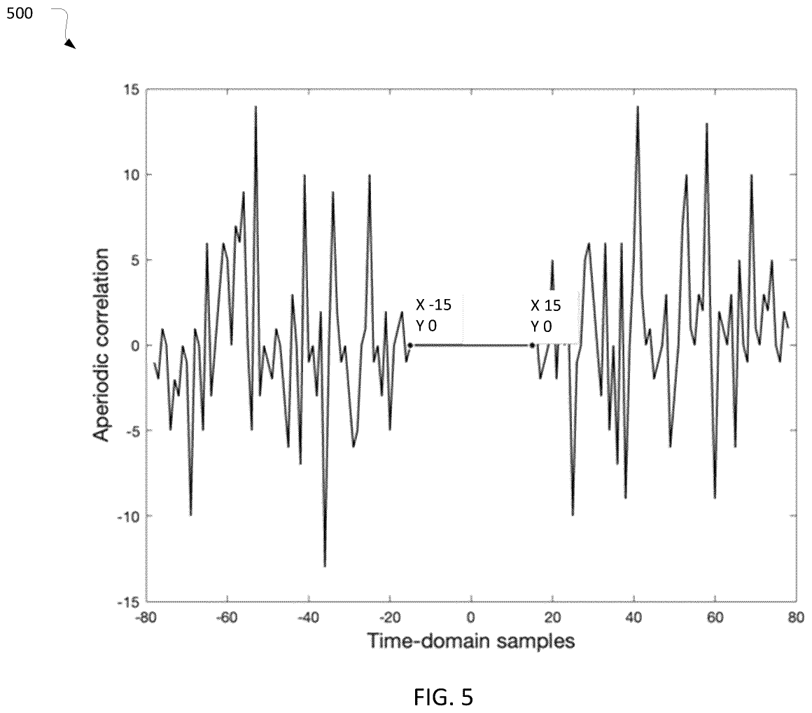

FIGS. 4 and 5 provide graphs depicting correlation properties in accordance with some embodiments. In particular, graph 400 of FIG. 4 illustrates an auto correlation of a single sequence and graph 500 of FIG. 5 illustrates a cross-correlation between two sequences (for example, RS sequences \tilde{s}₀ and \tilde{s}₁).

With respect to graph 400, a peak correlation value may be associated with an in-phase correlation coefficient. Zero correlation values (or approximately zero correlation values) may be associated with out-of-phase correlation coefficients within a certain sequence, time shift zone, or window referred to as [−T, T]. The value T is set to 15 in FIG. 4.

With respect to graph 500, zero (or approximately zero) correlation coefficients may occur within the sequence, time shift zone, or window [−T, T]. The value T is also set to 15 in FIG. 4. The zone having zero or approximately zero correlation coefficients may be referred to as the zero-correlation zone. As long as a delay between receiving two sequences is within the zero correlation zone, for example, no larger than T, the receiver may be able to perform channel estimation due to the desired auto-correlation property and to separate the two sequences due to the zero cross-correlation.

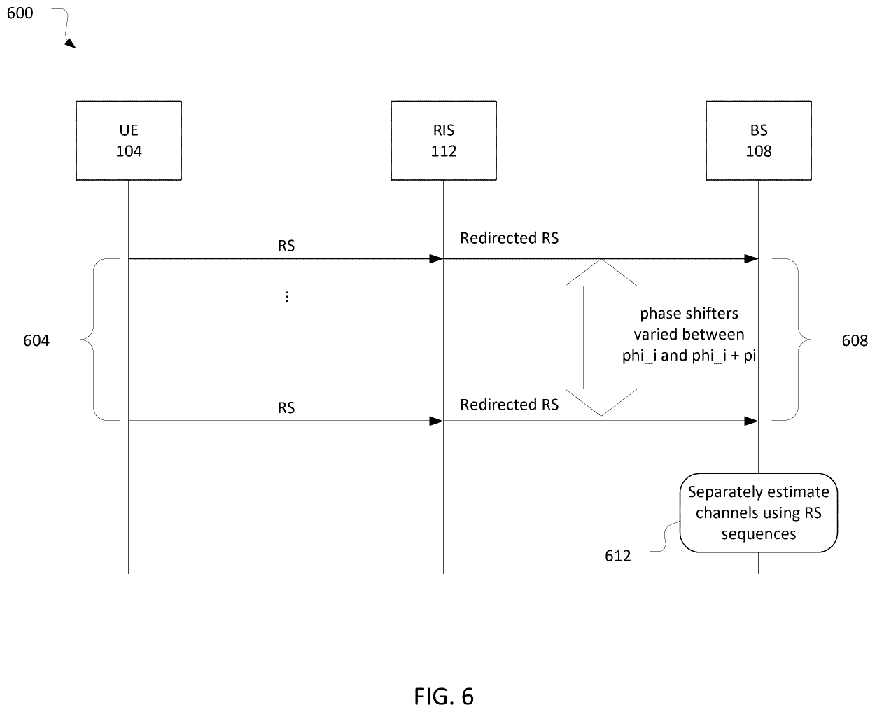

FIG. 6 illustrates a signaling diagram 600 to illustrate concepts of the first option in accordance with some embodiments. The signaling diagram 600 may include signals between, and operations performed by, the UE 104, the RIS 112, and the base station 108.

At 604, a transmitter of the UE 104 may send RS sequence \tilde{s}₀ in time domain. RS sequence \tilde{s}₀ may be transmitted directly to the base station 108 over a first channel h₀ and indirectly to the base station 108 via the RIS 112 over a second channel h₁.

Within transmission of so, shown as period 608, the RIS 112 is controlled to vary its phase shifters so that the effective RS sequence over transmitter-RIS-receiver link becomes \tilde{s}₁, where \tilde{s}₀ and \tilde{s}₁ have a zero correlation zone covering the delay difference of paths.

Assume at the beginning of period 608 the phase shifters of the RIS 112 are initially configured as ϕᵢ for antenna element i∈{1, 2, . . . , K} for pointing to correct direction during RIS beam management process. Then, within the transmission of so, RIS 112 is further controlled to configure/vary its phase shifters between ϕᵢ and ϕᵢ+π for all i∈{1, 2, . . . , K}. The additional phase shift π is either commonly applied to all RIS antenna elements or not. As long as the relative phase differences across RIS elements are kept the same, the beam direction from the RIS 112 may not change.

The phase change by π may only require a 1-bit phase shifter. This may, therefore, relax the requirement on the RIS 112. Depending on capabilities of the RIS 112, other embodiments may extend the phase change to other phases, which may require more bits to generate discrete phase shifters.

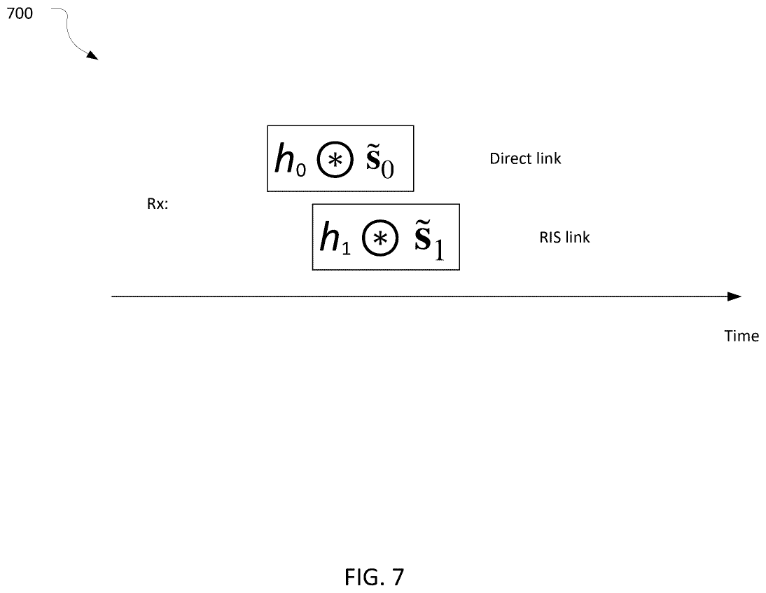

At 612, a receiver of the base station 108 may separately estimate channels using the two RS sequences. For example, the receiver may estimate h₀ and h₁ using \tilde{s}₀ and \tilde{s}₁, respectively. As shown in the diagram 700 of FIG. 7, due to the different path delays, the signals from the direct link and from the RIS link may not arrive at the receiver simultaneously. The transmission over the RIS link may arrive at the receiver after the transmission over the direct link. This fact may be considered for channel estimation.

The zero (auto-)correlation zone property of either \tilde{s}₀ or \tilde{s}₁ as well as the zero (cross-)correlation zone property between \tilde{s}₀ and \tilde{s}₁ may enable separate channel estimation of h₀ and h₁ using a single-channel receiver. This may be the case even with asynchronous arrival at the receiver. The zero correlation zone property may ensure the received two links are still orthogonal as long as the path delay difference is no longer than the zone size.

The RS sequence \tilde{s}₀ may be designed in a manner to facilitate the separate estimations. In some embodiments, the RS sequence \tilde{s}₀ may contain either a zero prefix (ZP) or a cyclic prefix (CP) to enable more efficient processing at a receiver. Three examples of RS sequence design and corresponding RIS operations are provided herein.

The RS \tilde{s}₀ may be specifically designed to facilitate embodiments of the present disclosure. In a first example, construction of the RS \tilde{s}₀ may be based on two orthogonal pairs of Golay complementary sequences with ZP. In a second example, construction of the RS \tilde{s}₀ may be based on a single pair of Golay complementary sequences with CP. And, in a third example, construction of the RS \tilde{s}₀ may be based on Zadoff-Chu (or more generally chirp) sequences with CP.

While embodiments describe the first option and associated sequence design for one UE and one RIS, they can be generalized for the scenarios of multi-UEs and single-RIS, single-UE and multi-RISs, and multi-UE and multi-RIS. Examples of the generalization will be provided.

According to the first example of the RS sequence design, the time-domain RS sequence sent from the UE 104 may be in the format of \tilde{s}₀=[0, s₀]=[0, x₀, x₁, 0, y₀, y₁]. In this case, a ZP may be added, for example, P_{s_0}=0.

0 is a zero vector with length M, which is no shorter than the maximum channel delay. The sequences x₀,x₁,y₀, and y₁ are specially designed sequences with the same length N. The value (min{2N−1,2M+1}−1)/2 is no smaller than the delay difference between two paths.

Two conditions on constructions of x₀,x₁,y₀, and y₁ may exist. Here Cₓ_{ᵢ}_{,y}_{ⱼ} denotes aperiodic correlation between sequences xᵢ and yⱼ.

A first condition may include both {x₀, x₁} and {y₀, y₁} being a pair of Golay complementary sequences, for example,

$${C}_{{x}_{0} , {x}_{0}} ( n ) + {C}_{{x}_{1} , {x}_{1}} ( n ) = \{ \begin{matrix}2 N , for n = 0 \\ 0 , for n \neq 0\end{matrix} , and$$

$${C}_{{y}_{0 ,} {y}_{0}} ( n ) + {C}_{{y}_{1} , {y}_{1}} ( n ) = \{ \begin{matrix}2 N , for n = 0 \\ 0 , for n \neq 0\end{matrix} .$$

A second condition may include the two Golay pairs being orthogonal with each other. Here two Golay pairs being orthogonal is defined as Cₓ_{₀}_{,y}_{₀}(n)+Cₓ_{₁}_{,y}_{₁}(n)=0, ∀n, and C_{y}_{₀}_{,x}_{₀}(n)+C_{y}_{₁}_{,x}_{₁}(n)=0, ∀n.

In some embodiments, x₀,x₁,y₀, and y₁ may be constructed as follows: {x₀, x₁} is a pair of Golay complementary sequences; and y₀=\tilde{x}₁ and y₁=−\tilde{x}₀, where \tilde{x}₁ denotes the reverse-ordered sequence. Hence {y₀, y₁} is also a pair of Golay complementary sequences.

The RIS 112 may vary its phase shifter within the transmission of the RS sequence, so that the effective RS for UE-RIS-BS channel becomes \tilde{s}₁=[0, s₁]=[0, x₀, −x₁, 0, y₀, −y₁]. The RIS phase shifters may be kept as ϕᵢ for all i∈{1, 2, . . . , K}, when reflecting x₀ and y₀. The RIS phase shifters may be configured to be ϕᵢ+π for all i∈{1, 2, . . . , K}, when reflecting x₁ and y₁. Hence, the effective sequences conveyed via the RIS link becomes −x₁ and −y₁. When reflecting 0, the RIS phase shifters can be either ϕᵢ or ϕᵢ+π for all i∈{1, 2, . . . , K}.

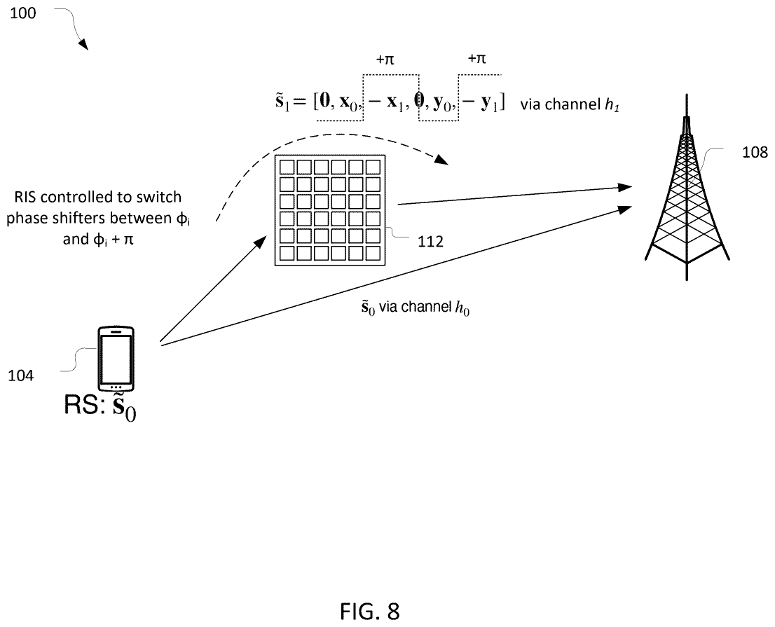

Referring to the network environment 100 of FIG. 8, only three RIS phase transitions may be needed. A first transition may be from ϕᵢ to ϕᵢ+π for redirection of −x₁; a second transition from ϕᵢ+π to ϕᵢ for redirection of 0 and y₀; and a third transition from ϕᵢ to ϕᵢ+π for redirection of −y₁. The second transition can be done when the waveform is all zeros. This infrequent transitioning may be preferable from practical hardware implementation perspective.

With the proposed design, both \tilde{s}₀ and \tilde{s}₁ have good aperiodic auto-correlation, for example, a delta function within the time window of length min{2N−1,2M+1}.

An example is shown graph 400 of FIG. 4, which the depicts auto-correlation of \tilde{s}₀ with N=16, M=15 in accordance with some embodiments. In this case, it is a delta function within the time-domain sample window [−15, 15]. Good aperiodic auto-correlation enables channel impulse response (CIR) estimation of one path, for example, h₀ or h₁. There can be multiple taps for each path.

The sequences \tilde{s}₀ and \tilde{s}₁ may also have good aperiodic cross-correlation, for example, a zero-correlation zone within the time window of length min{2N−1,2M+1}. An example is shown in the graph 500 of FIG. 5, which depicts cross-correlation between \tilde{s}₀ and \tilde{s}₁ with N=16, M=15 in accordance with some embodiments. In this case, it is a zero zone within the time-domain sample window [−15, 15]. Good aperiodic cross-correlation can efficiently separate the two paths, for example, h₀ and h₁. In this way, a receiver at the BS 108 can estimate h₀ and h₁ using \tilde{s}₀ and \tilde{s}₁ respectively.

The sequence format for the second and third examples of the RS sequence may be the same. Thus, the common construction format and receiver operations may be described first followed by more detailed explanations of underlying sequence options (for example, s₀, which will be explained later).

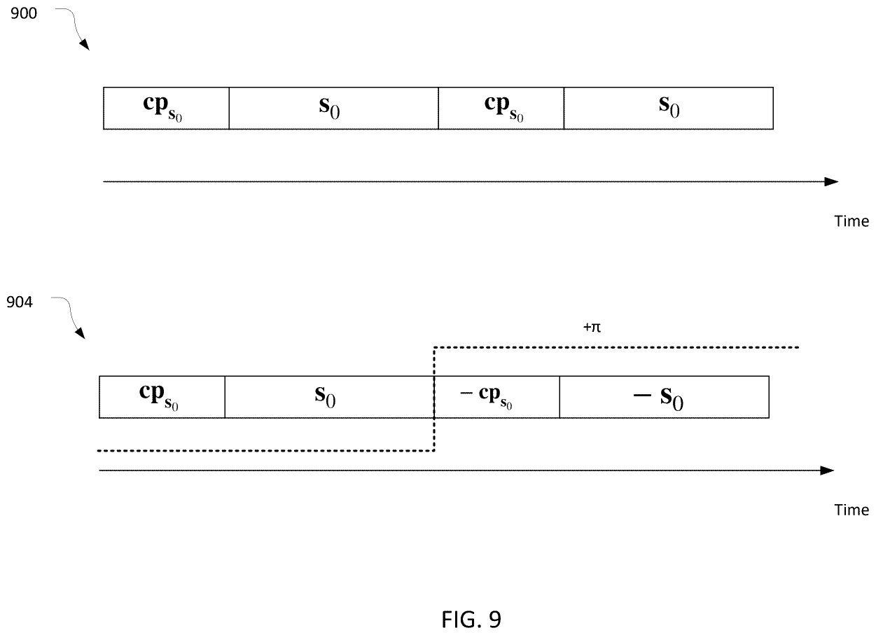

A time-domain RS sequence sent from the UE 104 may be in the format of \tilde{s}₀=[cpₛ_{₀}, s₀, cpₛ_{₀}, s₀], where s₀ can be considered as the basic building block of the sequence. CP is used here, for example, cpₛ_{₀} denotes the last portion of so, which should be no shorter than the maximum channel delay. FIG. 9 illustrates RS \tilde{s}₀=[cpₛ_{₀}, s₀, cpₛ_{₀}, s₀] 900 sent from UE 104 in accordance with some embodiments.

The RIS 112 may vary its phase shifter within the transmission of RS 900, so that the effective RS for UE-RIS-BS channel becomes RS \tilde{s}₁=[cpₛ_{₀}, s₀, −cpₛ_{₀}, −s₀] 904. Thus, a phase shift of π may be applied to the last two segments.

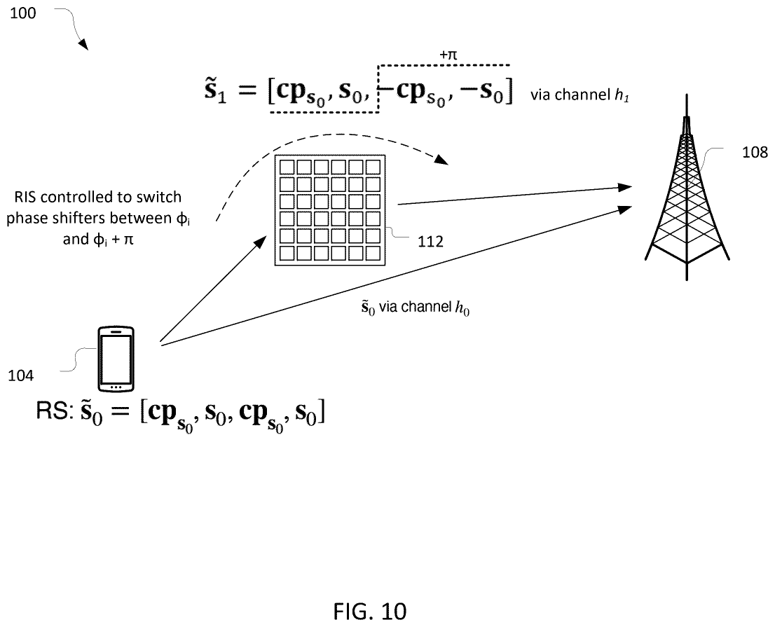

The network environment 1000 of FIG. 10 illustrates generation of an effective RS sequence \tilde{s}₁ for UE-RIS-BS channel via RIS phase shifter changes in accordance with some embodiments. The phase shifters of the RIS 112 may be kept as ϕᵢ for all i∈{1, 2, . . . , K} when reflecting the first cpₛ_{₀} and s₀. The phase shifters of the RIS 112 may be configured to be ϕᵢ+π for all i∈{1, 2, . . . , K} when reflecting the second cpₛ_{₀} and s₀; and thus the corresponding effective sequences conveyed via RIS link becomes [−cpₛ_{₀}, −s₀]. Thus, in this embodiment, only two RIS phase transitions are needed, for example, from ϕᵢ to ϕᵢ+π and from ϕᵢ+π to ϕᵢ. The infrequent transition provided in this manner may be desirable from a practical hardware implementation perspective.

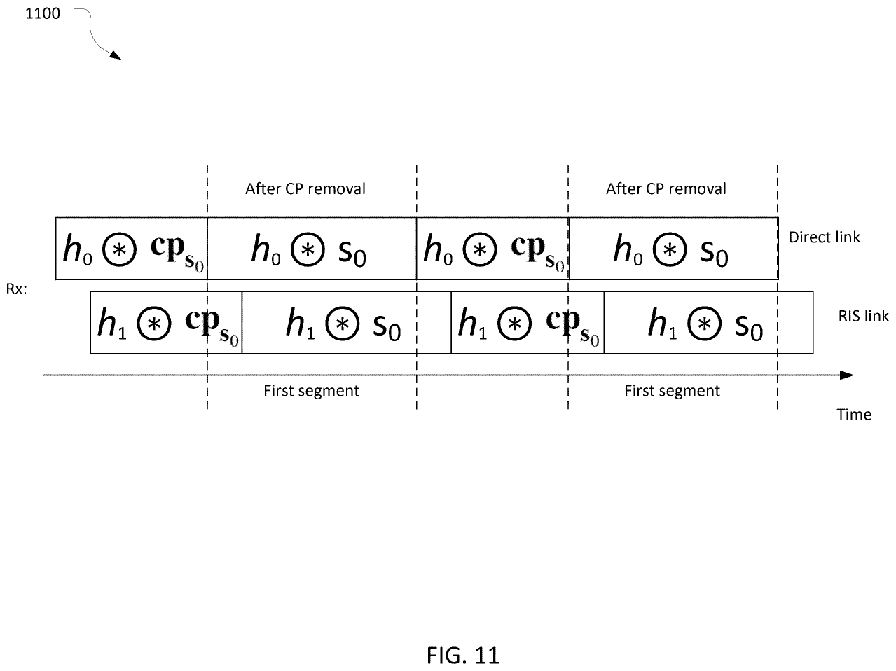

As shown in timing diagram 1100 of FIG. 11, due to different path delays, the signals from the direct link and the RIS link may not arrive at the receiver simultaneously. For illustration simplicity, single-path h₀ or h₁ is considered here. Nevertheless, h₀ or h₁ can be multi-path as well and then the received signals will be further spread in time domain.

For channel estimation of h₀(direct link), the first segment may be correlated with s₀ for a first correlation result and the second segment may be correlated with s₀ for a second correlation result. The correlation results may then be summed to derive h₀.

For channel estimation of h₁ (RIS link), the first segment may be correlated with s₀ for a first correlation result and the second segment may be correlated with −s₀ for a second correlation result. The correlation results may then be summed to derive h₁.

Due to the good periodic auto-correlation of s₀ and the fact that \tilde{C}_{[s}_{₀}_{,s}_{₀}_{],[s}_{₀}_{,-s}_{₀}_{]}=0, the receiver is able to separate h₀ and h₁. Here \tilde{C}_{x,y} denotes periodic correlation between sequences x and y.

Details of the underlying sequence options for the second and third examples of constructing so are provided as follows. For the second example, s₀=[x₀, −x₁, x₀, x₁], where {x₀, x₁} is pair of Golay complementary sequences. For third example, s₀=x₀, where x₀ is Zadoff-Chu sequence or, more generally, a chirp sequence.

Although the second and third examples are described for one UE and one RIS, they can be generalized for the scenarios of multi-UE and/or multi-RIS.

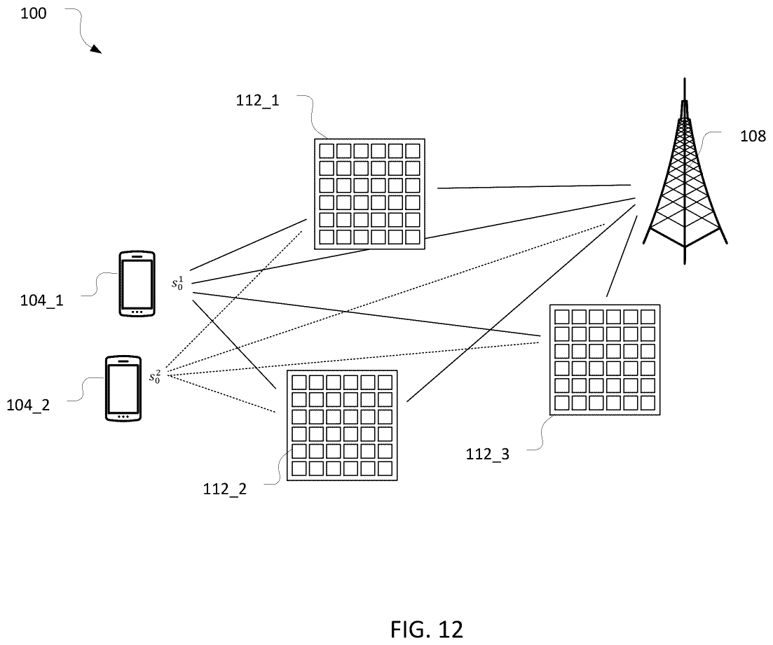

FIG. 12 illustrates the network environment 100 with a plurality of RISs, for example, RIS 112_1, RIS 112_2, and 112_3, with each redirecting transmissions from UE 104_1 or UE 104_2 to the base station 108 or vice versa.

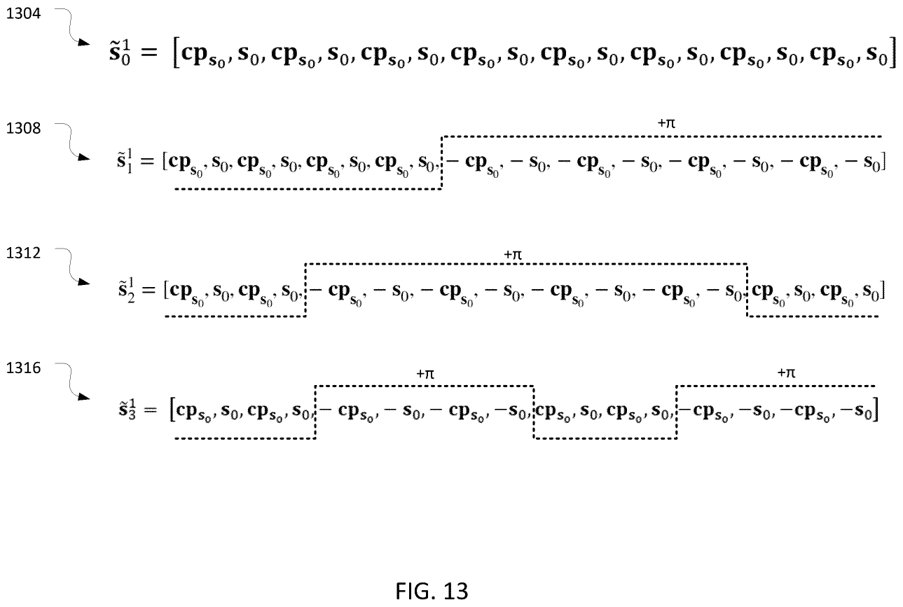

FIG. 13 illustrates RSs and effective RSs transmitted from UE 104_1 in the network environment 100 of FIG. 12. The RS sent from UE 104_1 is \tilde{s}₀¹ 1304 and, via respective phase shifter changes, the effective RS over RIS 112_1 becomes \tilde{s}₁¹ 308, the effective RS over RIS 112_2 becomes \tilde{s}₂¹ 312, and the effective RS over RIS 112_3 becomes \tilde{s}₃¹ 1316.

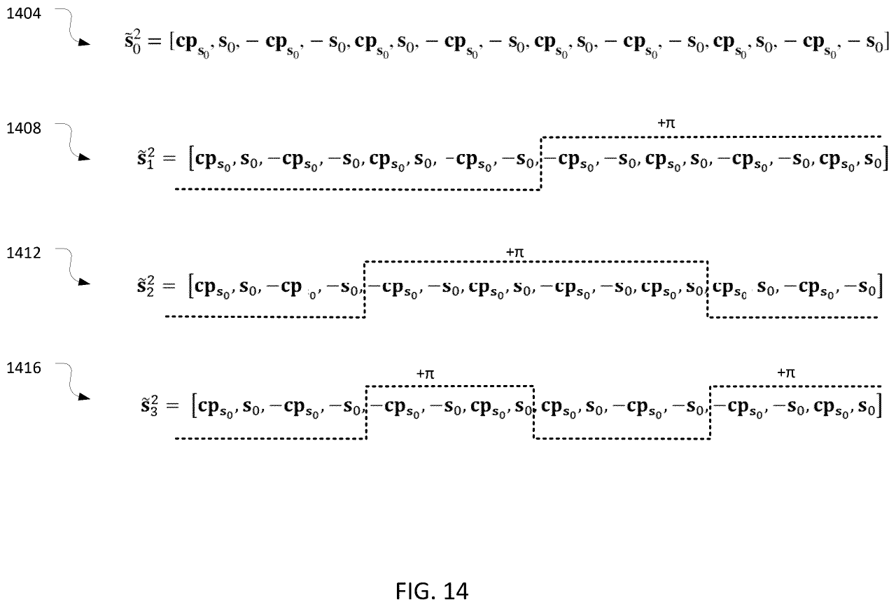

FIG. 14 illustrates RSs and effective RSs transmitted from UE 104_2 in the network environment 100 of FIG. 14. The RS sent from UE 104_2 is \tilde{s}₀² 1404 and, via respective phase shifter changes, the effective RS over RIS 112_1 becomes \tilde{s}₁² 1408, the effective RS over RIS 112_2 becomes \tilde{s}₂² 1412, and the effective RS over RIS 112_3 becomes \tilde{s}₃² 1416.

To explain receiver processing in the context of the network environment 100 as shown in FIG. 12, consider the following.

Denote the channel of the direct link between UE u and BS as h₀ᵤ, where u=1,2. Denote the channel of the cascaded RIS link “UE u-RIS q-BS” as h_{qu}, where q=1, 2, 3, and u=1, 2.

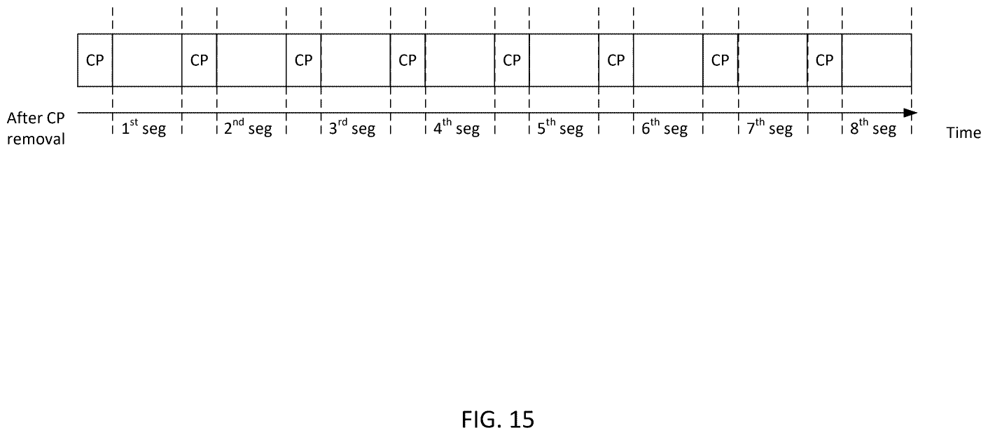

FIG. 15 illustrates format 1500 of a signal received by the base station 108 in the network environment 100 of FIG. 12.

To estimate the 8 channels separately, after removing CP the receiver correlates the 8 received segments with s₀ or −s₀ respectively. Then sum the results to derive the respective channel.

To estimate hoi, the receiver may correlate the 8 segments with {s₀, s₀, s₀, s₀, s₀, s₀, s₀, s₀} respectively. To estimate h₁₁, the receiver may correlate the 8 segments with {s₀, s₀, s₀, s₀, −s₀, −s₀, −s₀, −s₀}, respectively. To estimate h₂₁, the receiver correlates the 8 segments with {s₀, s₀, −s₀, −s₀, −s₀, −s₀, s₀, s₀}, respectively. To estimate h₃₁, receiver correlates the 8 segments with {s₀, s₀, −s₀, −s₀, s₀, s₀, −s₀, −s₀}, respectively. To estimate h₀₂, the receiver correlates the 8 segments with {s₀, −s₀, s₀, −s₀, s₀, −s₀, s₀, −s₀}, respectively. To estimate h₁₂, the receiver may correlate the 8 segments with {s₀, −s₀, s₀, −s₀, −s₀, s₀, −s₀, s₀}, respectively. To estimate h₂₂, the receiver may correlate the 8 segments with {s₀, −s₀, −s₀, s₀, −s₀, s₀, s₀, −s₀}, respectively. To estimate h₃₂, the receiver may correlate the 8 segments with {s₀, −s₀, −s₀, s₀, s₀, −s₀, −s₀, s₀}, respectively.

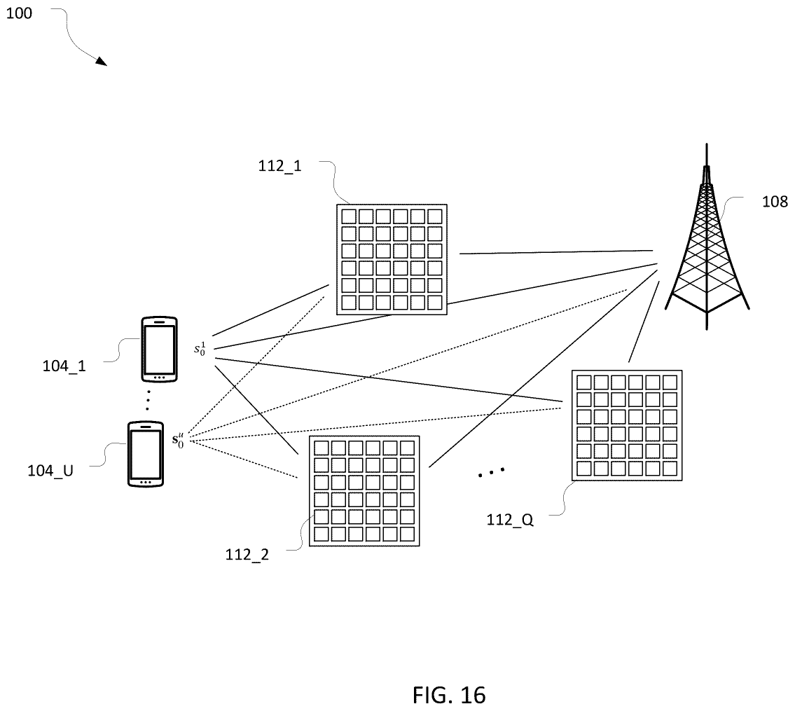

The generalizations for the scenarios of multi-UE and/or multi-RIS may be summarized as below and with respect to FIG. 16. FIG. 16 illustrates the network environment 100 with Q RISs, for example, RIS 112_1-RIS 112_Q, and U UEs, for example, UE 104_1-UE 104_U.

For a scenario with Q RISs (so there are in total Q+1 links including the direct link) and U UEs, a Hadamard matrix W of size P(P>Q) may be generated. Then for UE u, the time-domain RS sequence sent from UE u is

$${\tilde{s}}_{0}^{u} = 1 ⊗ {s}_{0}^{u} ,$$

where 1 is a row vector of size P and ⊗ denotes the Kronecker product. Moreover, there may be two alternatives of generating

$${s}_{0}^{u} .$$

In a first alternative:

$${s}_{0}^{u} = U ( u , : ) ⊗ [ c {p}_{{s}_{0 ,}} , {s}_{0} ] ,$$

where U(u,:) is the u-th row of a scaled unitary matrix (preferably with unit modulus entries) U with size U. The example given in FIG. 15 belongs to this alternative.

In a second alternative:

$${s}_{0}^{u} = [ c {p}_{{\hat{s}}_{0}^{u}} , {\hat{s}}_{0}^{u} ] and {\hat{s}}_{0}^{u}$$

is a cyclic shifted version of s₀. More specifically,

$${\hat{s}}_{0}^{u} [ l ] = {s}_{0} [ ( l + {C}_{u} ) mod L ] ,$$

where Cᵤ is the applied cyclic shift for UE u and L is the sequence length of s₀. When s₀ is Zadoff-Chu (or chirp) sequence, different roots (or chirp rates) with low cross-correlation can be used in different cells.

The phase shifters at the q-th RIS may be adjusted so that the effective RS sequence over that link becomes

$${\tilde{s}}_{q}^{u} = W ( q + 1 , : ) ⊗ {\tilde{s}}_{0}^{u} ,$$

where W(q+1,:) is the (q+1)-th row of Hadamard matrix W for q=1, 2, . . . , Q.

For channel estimations using the first option, changing the phase shifters of the RIS 112 may need to be synchronized with the RS sequence transmission. Thus, the RIS controller 116 may configure/trigger the RIS 112 to switch its phase shifters between ϕᵢ and ϕᵢ+π. This may be done in accordance with one or more of the following options.

In a first option, the RIS controller 116 may trigger the RIS 112 to switch its phase shifters after T1 seconds. For example, after T1 seconds, the RIS 112 may switch its phase shifters from ϕᵢ to ϕᵢ+π, wait T1 seconds and then switch its phase shifters from ϕᵢ+π to ϕᵢ, and so on. The value T1 may be determined/estimated by a starting time of an RS transmission, a delay between a transmitter and the RIS 112, and a duration of the designed RS sequence.

In a second option, the RIS controller 116 may configure the RIS 112 to switch its phase shifter from ϕᵢ to ϕᵢ+π every T2 seconds, and from ϕᵢ+π to ϕᵢ every T3 seconds. The values T2 and T3 may be determined/estimated based factors discussed above with respect to T1 and on a design of the RS sequence, for example, when the minus sign is applied.

While the above description focuses on determining separate channel estimations with the first option for uplink RS transmissions, similar concepts may also be applied to the downlink with some consideration of configuration and signaling aspects as described herein. Downlink reference signals may include, for example, demodulation reference signals (DMRSs) or channel state information-reference signals (CSI-RSs).

In some embodiments, the base station 108 may configure the UE 104 with Q+1 different RS sequence resources for direct BS-UE link and Q cascaded BS-RIS-UE links respectively. One sequence is the originally transmitted RS \tilde{s}₀ and the others are effectively generated from RIS phase shifter changes.

The base station 108 may also signals to the UE 104 to estimate the (Q+1)-port channel using the Q+1 sequences, respectively.

To report for the Q+1 links, the UE 104 may generate/transmit reports that are associated with corresponding RS resource configurations.

The second option for channel estimation may rely on RS orthogonalization in frequency domain via frequency modulation of the RIS 112.

In some embodiments, the RIS 112 may have frequency modulation capability. For example, the RIS 112 may be able to change an amplitude and phase of incoming narrowband signal according to a time-varying cosine function ϕ(t)=cos(2πfᵣt). With s(t) denoting the incoming time-domain signal with carrier frequency f_{c}, the signal reflected by the RIS 112 may be given by r(t)=s(t)ϕ(t)=s(t)cos(2πfᵣt). The reflected r(t) will appear at two different carrier frequencies f_{c}+fᵣ and f_{c}−fᵣ.

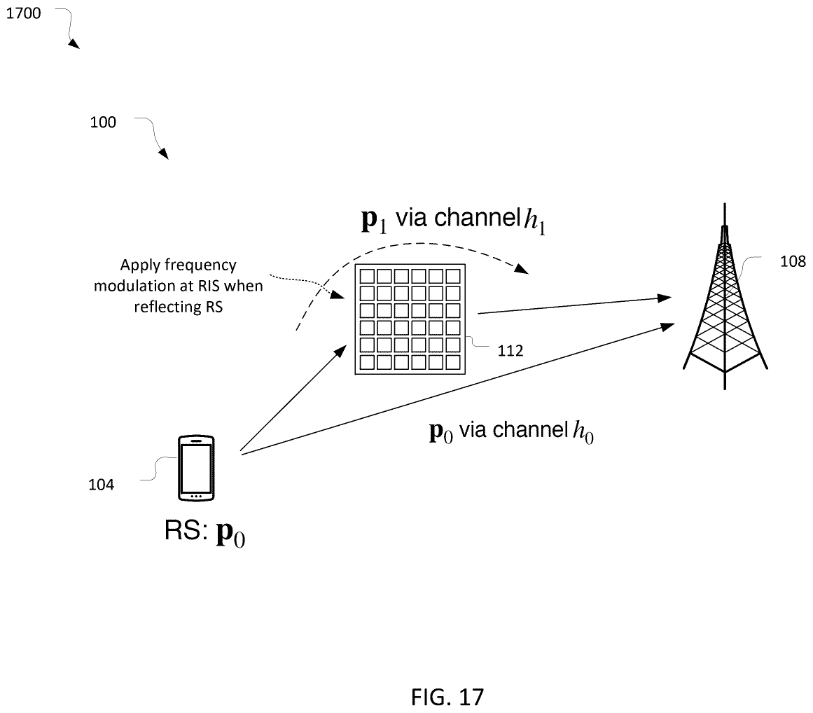

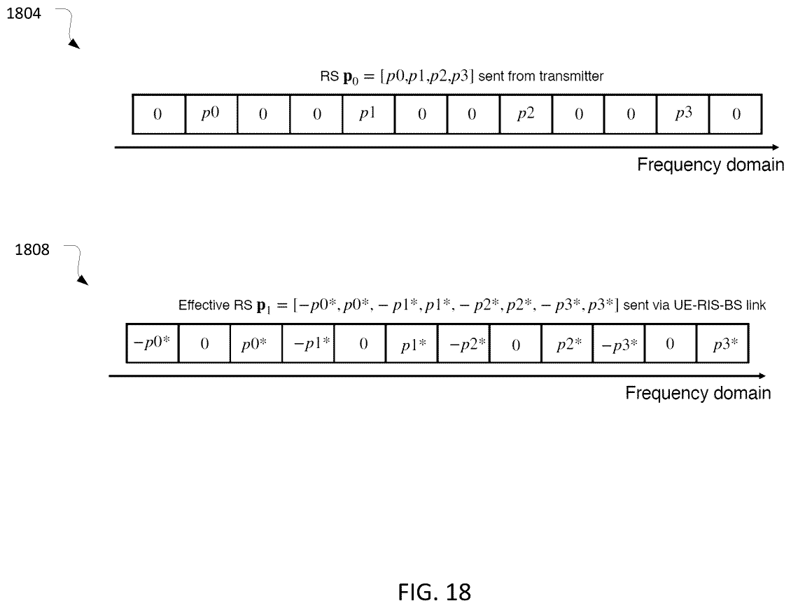

FIG. 17 illustrates separate channel estimations of the second option in the network environment 100 in accordance with some embodiments. The UE 104 may transmit an RS sequence (p₀) in frequency domain using comb manner as illustrated FIG. 18. This may be provided to the BS 108 via channel h₀. Within the transmission of RS sequence p₀, the RIS 112 may be controlled (by RIS controller 116) to provide frequency modulation s₀ that an effective RS sequence p₁ is provided to the base station 108 via channel h₁.

FIG. 18 illustrates RS sequence p₀ 1804 and effective RS sequence p₁ 1808 in accordance with some embodiments. In some instances, frequency-domain interpolation can be used to recover the channel estimates of the subcarriers carrying 0.

The second option is described assuming UL RS transmission; however, it can be similarly applied to DL, for example, DMRS or CSI-RS. Some configuration and signaling aspects with respect to DL transmissions are described.

The base station 108 may configure the UE 104 with one RS sequence p₀ but two different sets of RS frequency resources for direct BS-UE link and cascaded BS-RIS-UE link, respectively. One set of frequency resources carry p₀ and the other set carry p₁.

The base station 108 may also signal to the UE 104 to estimate the two-port channel using the RS on the two sets of frequency resources, respectively.

For reporting for the two links, the UE 104 may generate/transmit reports that are associated with the corresponding RS resource configurations.

The third option for channel estimation may rely on separate channel estimation via simultaneous beams.

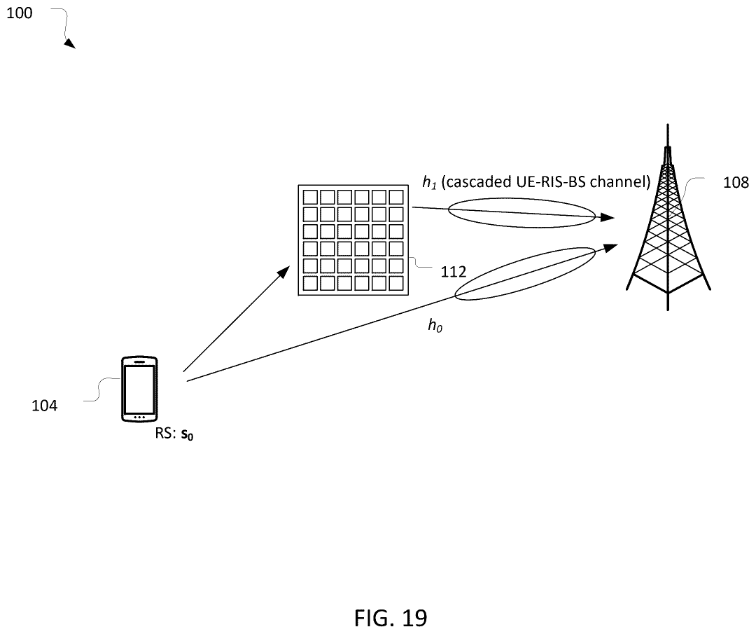

FIG. 19 illustrates separate channel estimations of the third option in the network environment 100 in accordance with some embodiments. The UE 104 may transmit an RS sequence (s₀). This may be provided to the BS 108 via channel h₀ over a direct link and may be provided to the BS 108 via channel h₁ over the indirect link.

The receiver at the base station 108 may form two narrow beams simultaneously. One beam may point to the transmitter/UE 104, and the other beam may point to the RIS 112 as shown in FIG. 19. The receiver may then generate estimates for channel h₀ and channel h₁ using the two Rx beams, respectively.

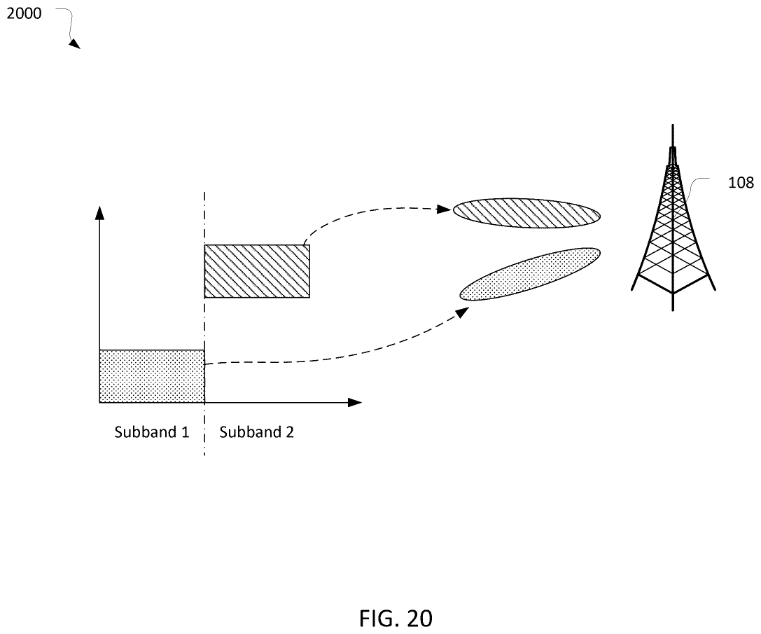

One way to achieve the simultaneous (narrow) beams is to use phase-time-array architecture where the time delays can be added in analog or digital domain. In some embodiments the phase-time-array architecture may use a single set of phase-delay configurations to form two beams at two subbands pointing to different directions, as shown in the diagram 2000 of FIG. 20 in accordance with some embodiments.

In addition to phase-time-array, beam squinting effects of phase-array can also be utilized to generate two simultaneous beams.

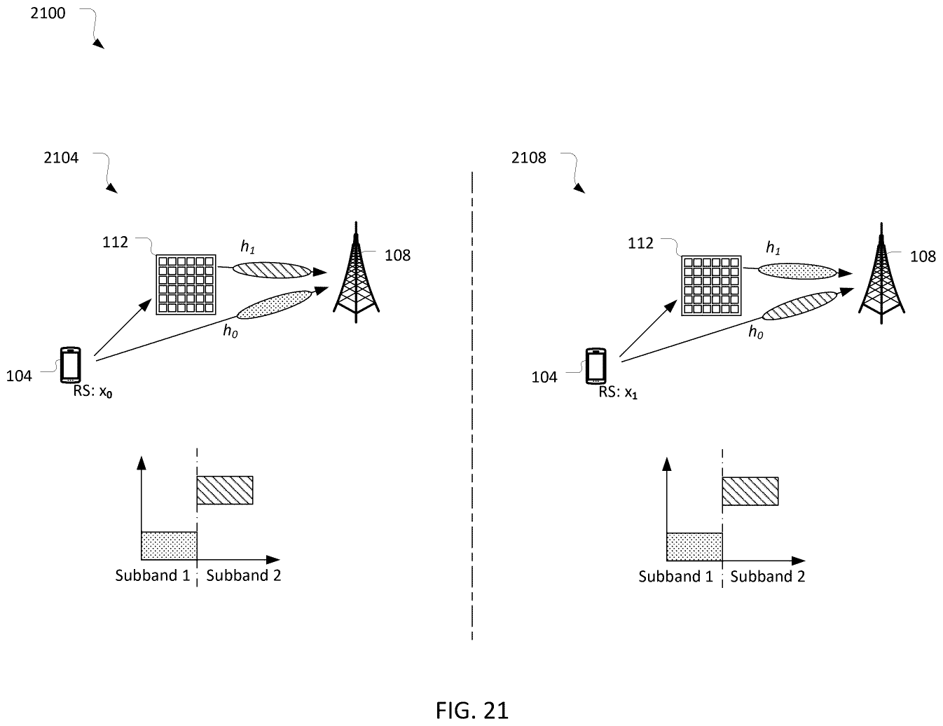

FIG. 21 illustrates a diagram 2100 in which the base station uses a phase-time-array architecture for channel estimation of the third option in accordance with some embodiments. In this embodiment, the transmitter may send an RS in the format of s₀=[x₀, x₁] in time domain. When receiving x₀, shown at 2104, one set of phase-time parameters are configured at the base station 108 to form two beams at two subbands respectively, one pointing to the UE 104 and the other one pointing to the RIS 112. When receiving x₁, shown at 2108, another set of phase-time parameters are configured at the base station 108 to form two beams at two subbands, respectively. At 2108, the beam directions at the two subbands are switched from that shown at 2104. In this way, the receiver at the base station 108 can estimate h₀ and h₁ separately for the entire band.

While the third option is described assuming UL RS transmission, it can also be applied to DL, for example, for DMRS or CSI-RS. Some configuration and signaling aspects are as follows.

The base station 108 may configure the UE 104 with two different sets of RS frequency resources, e.g., subband 1 and subband 2, which may be used for estimating direct BS-UE channel and cascaded BS-RIS-UE channel.

The base station 108 may also configure a switching time t, which indicates how long the UE 104 should use subband 1 for estimating BS-UE channel and subband 2 for BS-RIS-UE channel; and then switch to subband 2 for BS-UE channel and subband 1 for BS-RIS-UE channel. The switching time t can be in the format of number of slots, (OFDM) symbols, or time samples.

For example, if the switching time t is configured as 7 OFDM symbols, within the first 7 OFDM symbols of a slot, the UE 104 uses subband 1 for estimating the BS-UE channel and subband 2 for estimating the BS-RIS-UE channel; and then within the remaining 7 symbols, the UE 104 uses subband 2 for estimating the BS-UE channel and subband 1 for estimating the BS-RIS-UE channel.

In the fourth option, separate channel estimation may be performed via RIS group delay.

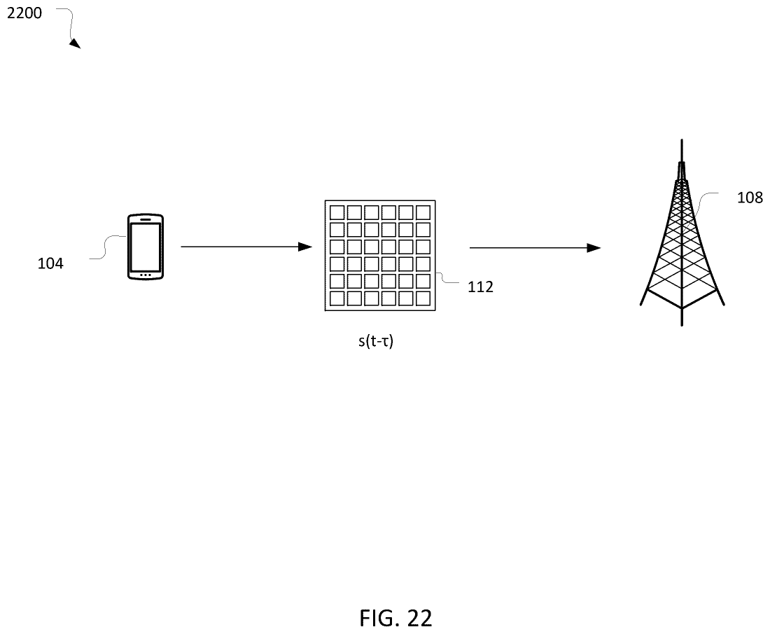

FIG. 22 illustrates a diagram 2200 in which group delay is used for channel estimation of the fourth option in accordance with some embodiments. A group delay may be indicated from the base station 108 to the RIS 112. The group delay can be applied to distinguish the direct link from the RIS channel(s). In some embodiments, the group delay may be determined based on a maximum delay of the direct link channel. The base station 108 may estimate the maximum delay of the direct link channel based on the turning-off period of the RIS 112. The turning-off period may be long (e.g., several hundred milliseconds). In some embodiments, the location information may be used to estimate the maximum delay or RIS group delay.

The base station 108 may distinguish and estimate channels for direct link and RIS link through appropriate windowing operations. A starting point and length of the window may be determined based on the group delay.

In some embodiments, the group delay can be implemented by full passive circuits (LC delay, RC delay) or low-power active circuits (switched capacitor delay line, true time delay line, etc.).

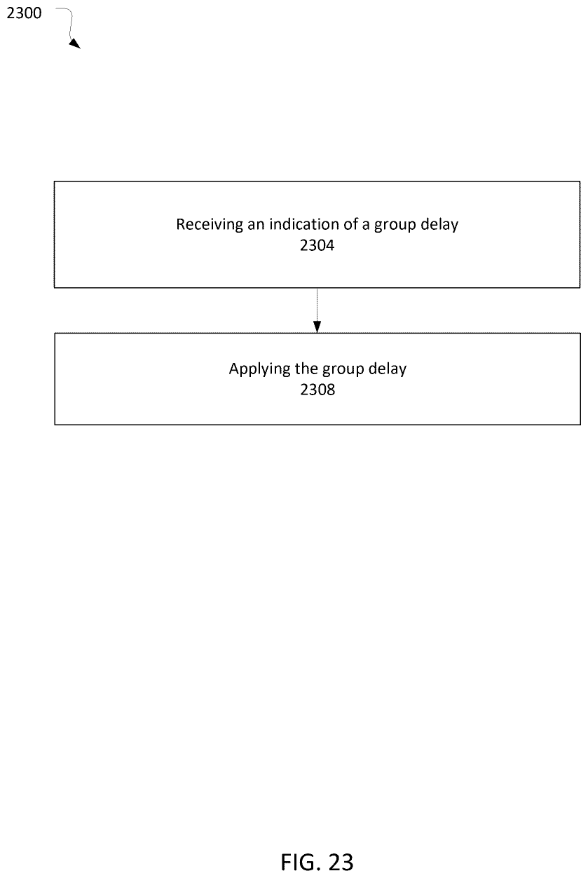

FIG. 23 is an operation flow/algorithmic structure 2300 illustrating group delay operation in accordance with some embodiments. The operation flow/algorithmic structure 2300 may be implemented by a RIS (e.g., RIS 112), RIS controller (e.g., RIS controller 116), device 3000 or components therein, e.g., processors 3004.

The operation flow/algorithmic structure 2300 may include, at 2304, receiving an indication of a group delay. In some embodiments, the indication may be received from a base station.

The operation flow/algorithmic structure 2300 may further include, at 2308, applying the group delay. For example, a RIS may be controlled to apply the group delay to a reference signal that is sent from a UE to a base station.

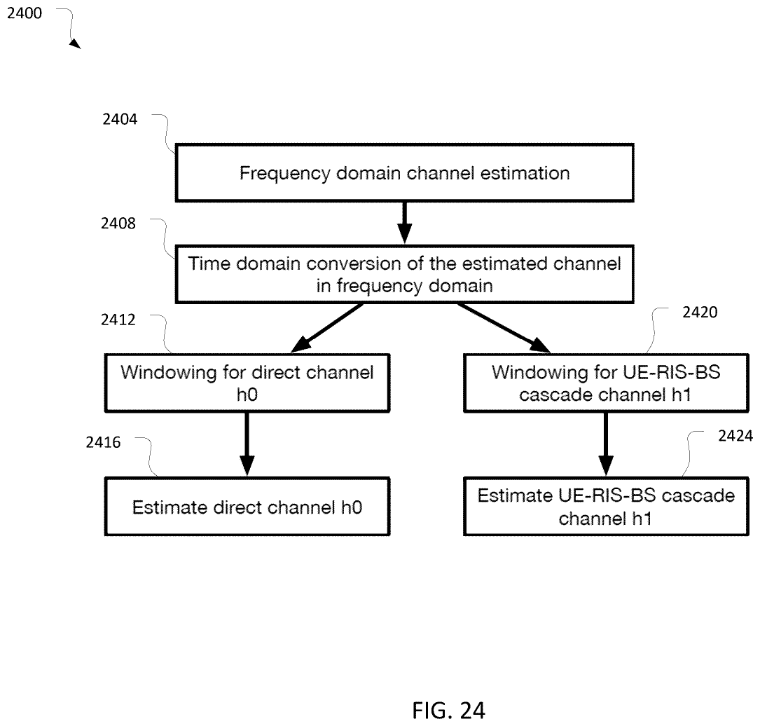

FIG. 24 is an operation flow/algorithmic structure 2400 illustrating channel estimation in accordance with some embodiments. The operation flow/algorithmic structure 2400 may be implemented by a receiver in the UE 104 or base station 108, device 3000, or network device 3100, or components therein, e.g., processors 3004 or 3104.

The operation flow/algorithmic structure 2400 may include, at 2404, performing a frequency domain channel estimation.

The operation flow/algorithmic structure 2400 may further include, at 2408, performing a time domain conversion of the estimated channel in frequency domain.

The operation flow/algorithmic structure 2400 may further include, at 2412, windowing for direct channel h₀.

The operation flow/algorithmic structure 2400 may further include, at 2416, estimating the direct channel h₀.

The operation flow/algorithmic structure 2400 may further include, at 2420, windowing for UE-RIS-BS channel h₁.

The operation flow/algorithmic structure 2400 may further include, at 2424, estimating the UE-RIS-BS channel h₁.

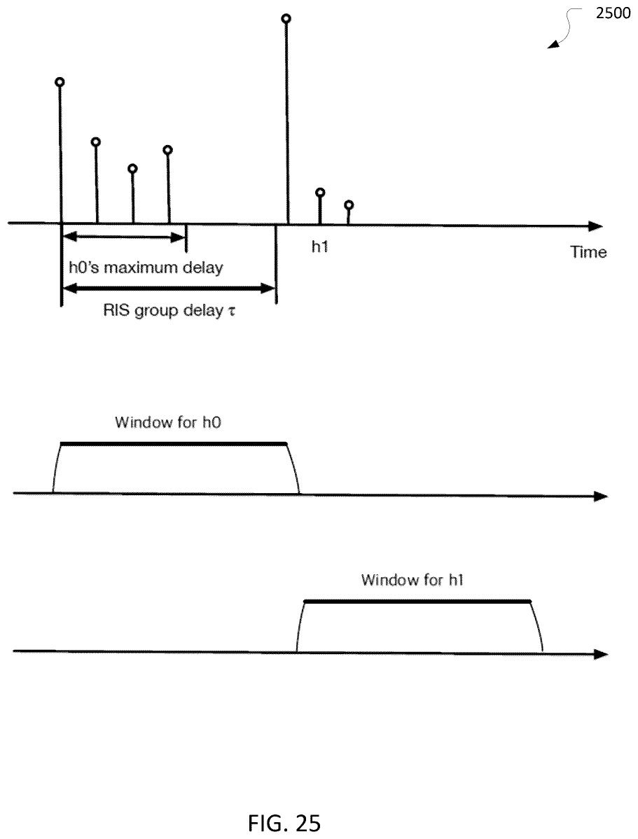

FIG. 25 illustrates timing diagrams 2500 depicting the windowing operation in accordance with some embodiments. The window for h₀ may be used to estimate the direct channel, while the window for h₁, which may be after the RIS group delay t, may be used to estimate the indirect channel.

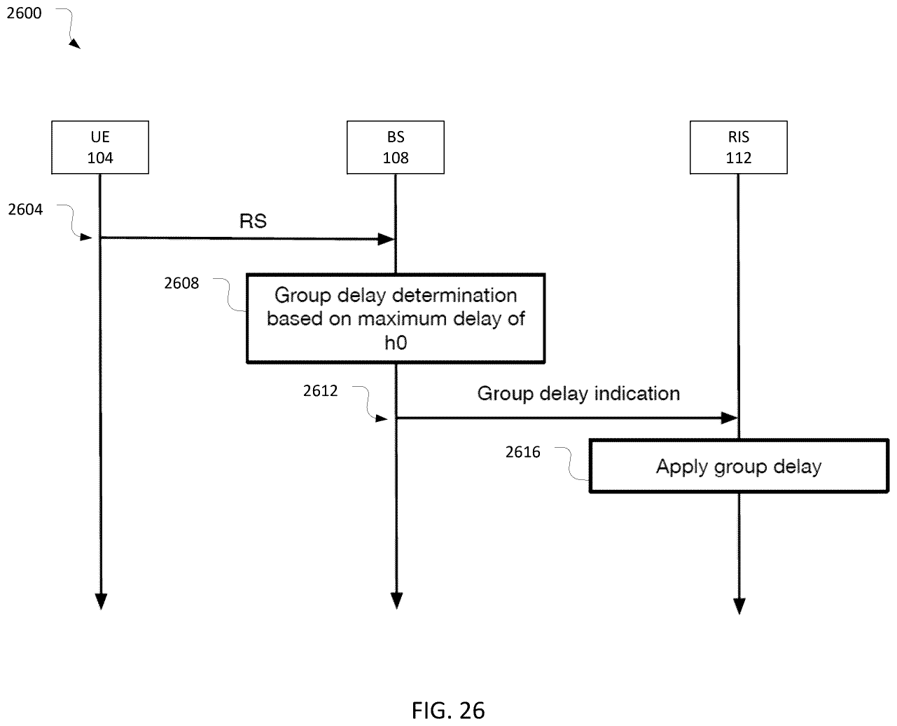

FIG. 26 illustrates a signaling 2600 depicting a group delay application procedure in accordance with some embodiments.

At 2604, the UE 104 may send an RS to the base station 108. At 2608, the base station 108 may determine a group delay based on a maximum delay of h₀, which may be determined based on the RS.

At 2612, the base station 108 may provide an indication of the group delay to the RIS 112. The RIS 112 may apply the group delay at 2616.

In existing channel estimation algorithms, the time domain channel conversion from the frequency domain estimated channel is applied for a de-noising process. Thus, it may be relatively straightforward to apply the time domain windowing operation to decouple the direct channel and the RIS channel.

The RIS channel can have a reduced maximum delay spread due to the beamformed channel effect due to large antenna elements, so there can be more room for the group delaying operation to be confined in CP length. A CP length is usually designed for maximum cell coverage. However, in a typical use case, for example, indoor cell, small cell or even in micro cell, an actual delay spread is much less than CP length. Two options may be used to utilize this effect. In a first option, the CP length may be reduced and a new numerology may be introduced (e.g., introducing shorter CP and different number of symbols in a slot). In a second option, the normal CP length may be used as is, but it can be used for another purpose such as applying group delay for separate channel estimation for direct link and RIS link.

While the fourth option is described assuming UL RS transmission, it can also be applied to DL, for example, for DMRS or CSI-RS. Some configuration and signaling aspects are as follows.

The base station 108 may configure the UE 104 with one RS sequence and a group delay indication for the UE 104 to estimate direct BS-UE channel and cascaded BS-RIS-UE channel. Then, the UE 104 may distinguish and estimate channels for direct BS-UE link and BS-RIS-UE link through appropriate windowing operations based on the indicated group delay.

As described herein, for RIS-assisted transmissions, separate channel estimation of the direct link and RIS link may be beneficial in several scenarios. These scenarios include, but are not limited to, closed-loop precoding, separate CQI estimation, multi-RIS selection, and RIS assisted positioning.

Various embodiments have been described to enable the separate channel estimation in an efficient manner.

The first option described RS orthogonalization in code domain via changing RIS phase shifters. Using phase shifter changes at the RIS, the cross-correlation between the RS sequence over the direct link and the effective RS sequence over RIS link may preserve a zero cross-correlation zone, so that the receiver can estimate the two channels separately.

The second option described RS orthogonalization in frequency domain via frequency modulation at RIS. Using frequency modulation capability at the RIS 112, the sent RS sequence over the direct link and the effective RS sequence over RIS link are orthogonal in frequency domain.

The third option described separate channel estimation via simultaneous beams. Separate channel estimation can be achieved via simultaneous beams formed at the BS side, where one of them points to UE while the other one points to RIS.

The fourth option described separate channel estimation via RIS group delay. A group delay is indicated to RIS, so that an appropriate delay is applied at RIS to make the receiver to be able to distinguish the channel estimates of the direct link and RIS link.

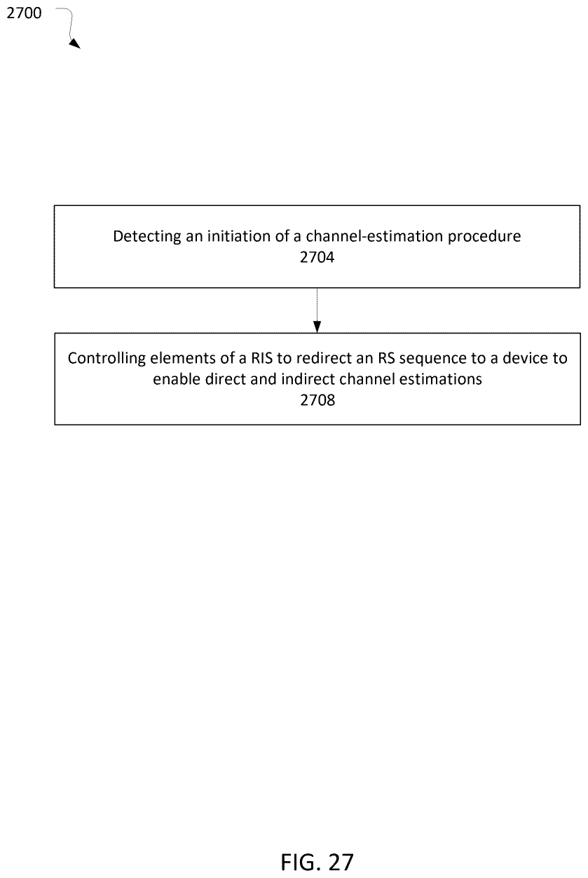

FIG. 27 is an operation flow/algorithmic structure 2700 illustrating channel estimation in accordance with some embodiments. The operation flow/algorithmic structure 2700 may be implemented by a RIS (e.g., RIS 112), RIS controller (e.g., RIS controller 116), device 3000 or components therein, e.g., processors 3004.

The operation flow/algorithmic structure 2700 may include, at 2704, detecting an initiation of a channel estimation procedure. In some embodiments, the detection may be based on an indication or schedule provided a UE or base station.

The operation flow/algorithmic structure 2700 may further include, at 2708, controlling elements of a RIS to redirect an RS sequence to a device to enable direct and indirect channel estimations. This may be done based on any of the options described herein. For example, the redirection may be with a code, frequency-domain, or time-domain transformation to enable direct and indirect channel estimations.

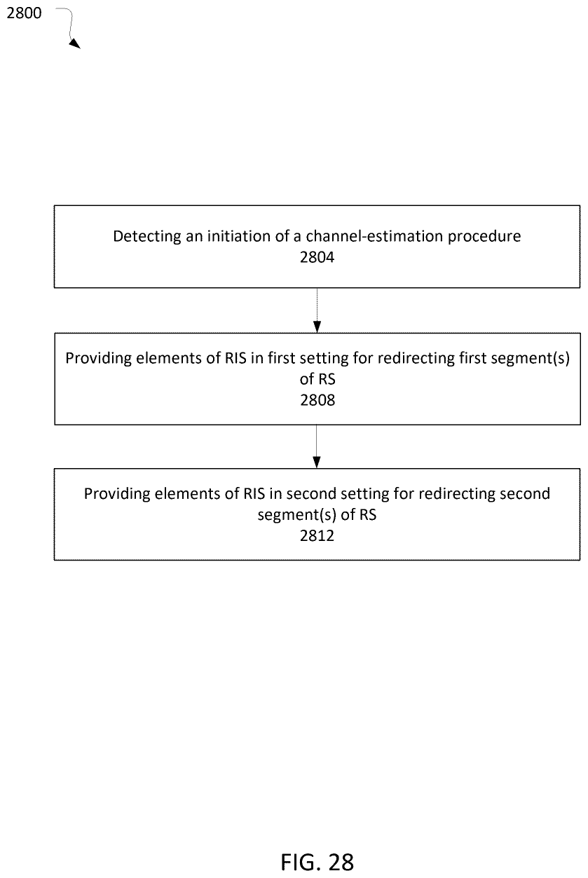

FIG. 28 is an operation flow/algorithmic structure 2800 in accordance with some embodiments. The operation flow/algorithmic structure 2800 may be implemented by a RIS (e.g., RIS 112), RIS controller (e.g., RIS controller 116), device 3100 or components therein, e.g., processors 3104.

The operation flow/algorithmic structure 2800 may include, at 2804, detecting an initiation of a channel estimation procedure. In some embodiments, the detection may be based on an indication or schedule provided a UE or base station.

The operation flow/algorithmic structure 2800 may further include, at 2808, providing elements of RIS in a first setting for redirecting first segment(s) of an RS sequence that is transmitted from a UE to a base station. The elements may provide a first phase shift (ϕᵢ) in the first setting, where i∈{1, 2, . . . , K} and K is a number of the plurality of elements.

The operation flow/algorithmic structure 2800 may further include, at 2812, providing elements of RIS in a first setting for redirecting second segment(s) of the RS sequence. The elements may provide a second phase shift (ϕᵢ+π) in the second setting,

The RS sequence provided to the BS over a direct link from the UE is a first sequence (\tilde{s}₀). The RS sequence provided to the BS over an indirect link via the RIS is a second sequence (\tilde{s}₁). The RIS may be controlled in a manner such that a cross-correlation of the first sequence (\tilde{s}₀) and the second sequence (\tilde{s}₁) provides a zero-correlation zone that covers a path delay difference associated with the direct link and the indirect link.

In some embodiments, the first sequence (\tilde{s}₀) may include a first pair of Golay complementary sequences; and a second pair of Golay complementary sequences. The first pair of Golay complementary sequences may be orthogonal with the second pair of Golay complementary sequences. For example, if {x₀, x₁} is the first pair of Golay complementary sequences and {y₀, y₁} is the second pair of Golay complementary sequences, then y₀=\tilde{x}₁ and y₁=−\tilde{x}₀, where \tilde{x}₁ is a reverse-ordered sequence of x₁ and \tilde{x}₀ is a reverse-ordered sequence of x₀.

In some embodiments, the first sequence has a zero prefix and is in a format of [0, x₀, x₁, 0, y₀, y₁].

In some embodiments, the first sequence (\tilde{s}₀) and the second sequence (\tilde{s}₁) may be defined by \tilde{s}₀=[cpₛ_{₀}, s₀, cpₛ_{₀}, s₀]; and \tilde{s}₁=[cpₛ_{₀}, s₀, −cpₛ_{₀}, −s₀], where s₀ is the first segment, −s₀ is the second segment, and cpₛ_{₀} is a cyclic prefix for s₀. The first segment may be defined as: s₀=[x₀, −x₁, x₀, x₁], where {x₀, x₁} is a pair of Golay complementary sequences. In some embodiments, the first segment may be defined as: s₀=x₀, where x₀ is a chirp sequence.

In some embodiments, the elements may make one or more transitions between the first setting and the second setting. The switch between the first setting and the second setting may occur after a predetermined period of time. In some embodiments, the RIS may switch from the first setting to the second setting after a first period of time and may switch from the second setting to the first setting after a second predetermined period of time. The periods of time may be configured by the base station or the UE.

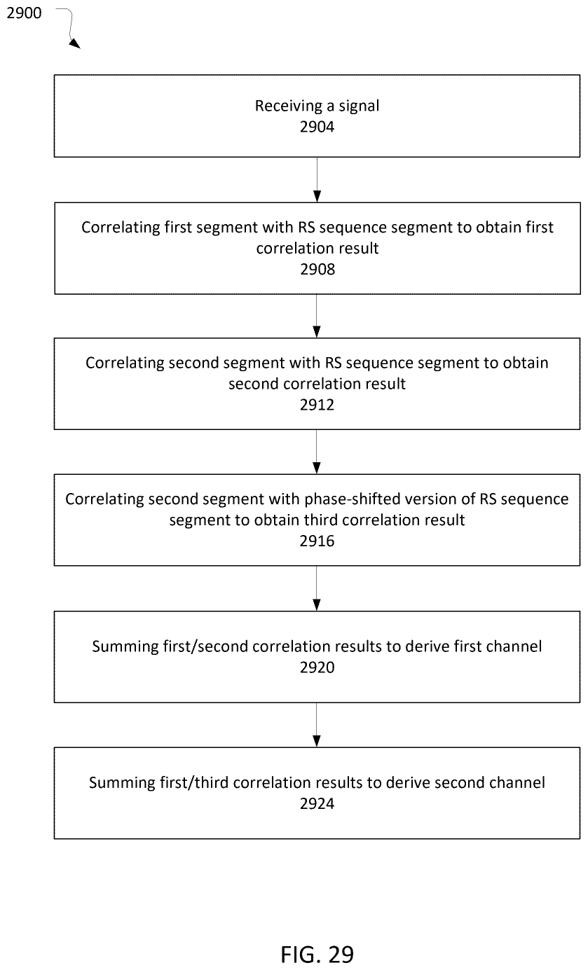

FIG. 29 is an operation flow/algorithmic structure 2900 illustrating a channel estimation operation in accordance with some embodiments. The operation flow/algorithmic structure 2900 may be implemented by a receiver of UE 104, base station 108, device 3000, network device 3100; or components therein, e.g., processors 3004 or 3104.

The operation flow/algorithmic structure 2900 may include, at 2904, receiving a signal. The signal, which may be received by one receive chain, may be a combination of a first RS sequence received over a direct link and a second RS sequence received over an indirect link via a RIS.

The operation flow/algorithmic structure 2900 may include, at 2908, correlating a first segment with an RS sequence segment to obtain a first correlation result.

The operation flow/algorithmic structure 2900 may include, at 2912, correlating a second segment with the RS sequence segment to obtain a second correlation result.

The operation flow/algorithmic structure 2900 may include, at 2916, correlating the second segment with a phase shifted version of the RS sequence segment to obtain a third correlation result. The phase-shifted version of the RS sequence may be shifted by a phase of n.

The operation flow/algorithmic structure 2900 may include, at 2920, summing the first and second correlation results to derive a first channel. The first channel may be associated with the direct link between the UE and the base station.

The operation flow/algorithmic structure 2900 may include, at 2924, summing the first and third correlation results to derive a second channel. The second channel may be associated with the indirect link between the UE and the base station via the RIS.

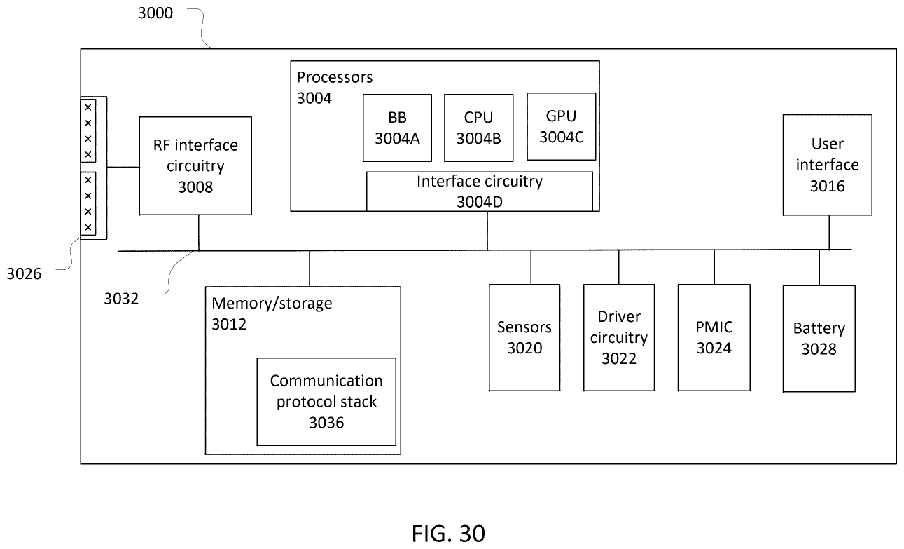

FIG. 30 illustrates a device 3000 in accordance with some embodiments. The device 3000 may be similar to, and substantially interchangeable with, UE 104 or RIS controller 306.

The device 3000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The device 3000 may include processors 3004, RF interface circuitry 3008, memory/storage 3012, user interface 3016, sensors 3020, driver circuitry 3022, power management integrated circuit (PMIC) 3024, antenna 3026, and battery 3028. The components of the device 3000 may be implemented as integrated circuits (ICs), portions thereof, discrete electronic devices, or other modules, logic, hardware, software, firmware, or a combination thereof. The block diagram of FIG. 30 is intended to show a high-level view of some of the components of the device 3000. However, some of the components shown may be omitted, additional components may be present, and different arrangement of the components shown may occur in other implementations.

The components of the device 3000 may be coupled with various other components over one or more interconnects 3032, which may represent any type of interface, input/output, bus (local, system, or expansion), transmission line, trace, or optical connection that allows various circuit components (on common or different chips or chipsets) to interact with one another.

The processors 3004 may include processor circuitry such as, for example, baseband processor circuitry (BB) 3004A, central processor unit circuitry (CPU) 3004B, and graphics processor unit circuitry (GPU) 3004C. The processors 3004 may include any type of circuitry or processor circuitry that executes or otherwise operates computer-executable instructions, such as program code, software modules, or functional processes from memory/storage 3012 to cause the device 3000 to perform channel estimation, reference signal transmission, or RIS control as described herein. The processors 3004 may also include interface circuitry 3004D to communicatively couple the processor circuitry with one or more other components of the device 3000.

In some embodiments, the baseband processor 3004A may access a communication protocol stack 3036 in the memory/storage 3012 to communicate over a 3GPP compatible network. In general, the baseband processor 3004A may access the communication protocol stack 3036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 3008.

The baseband processor 3004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 3012 may include one or more non-transitory, computer-readable media that includes instructions (for example, communication protocol stack 3036) that may be executed by one or more of the processors 3004 to cause the device 3000 to perform various operations associated with UE procedures as described herein.

The memory/storage 3012 includes any type of volatile or non-volatile memory that may be distributed throughout the device 3000. In some embodiments, some of the memory/storage 3012 may be located on the processors 3004 themselves (for example, memory/storage 3012 may be part of a chipset that corresponds to the baseband processor 3004A), while other memory/storage 3012 is external to the processors 3004 but accessible thereto via a memory interface. The memory/storage 3012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 3008 may include transceiver circuitry and a radio frequency front module (RFEM) that allows the device 3000 to communicate with other devices over a radio access network. The RF interface circuitry 3008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 3026 and proceed to filter and amplify (with a low-noise amplifier) the signal. The signal may be provided to a receiver of the transceiver that down-converts the RF signal into a baseband signal that is provided to the baseband processor of the processors 3004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 3026.

In various embodiments, the RF interface circuitry 3008 may be configured to transmit/receive signals in a manner compatible with NR access technologies.

The antenna 3026 may include antenna elements to convert electrical signals into radio waves to travel through the air and to convert received radio waves into electrical signals. The antenna elements may be arranged into one or more antenna panels. The antenna 3026 may have antenna panels that are omnidirectional, directional, or a combination thereof to enable beamforming and multiple input, multiple output communications. The antenna 3026 may include microstrip antennas, printed antennas fabricated on the surface of one or more printed circuit boards, patch antennas, or phased array antennas. The antenna 3026 may have one or more panels designed for specific frequency bands including bands in FR1 or FR2.

The user interface 3016 includes various input/output (I/O) devices designed to enable user interaction with the device 3000. The user interface 3016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the device 3000.

The sensors 3020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 3022 may include software and hardware elements that operate to control particular devices that are embedded in the device 3000, attached to the device 3000, or otherwise communicatively coupled with the device 3000. The driver circuitry 3022 may include individual drivers allowing other components to interact with or control various input/output (I/O) devices that may be present within, or connected to, the device 3000. For example, driver circuitry 3022 may include a display driver to control and allow access to a display device, a touchscreen driver to control and allow access to a touchscreen interface, sensor drivers to obtain sensor readings of sensors 3020 and control and allow access to sensors 3020, drivers to obtain actuator positions of electro-mechanic components or control and allow access to the electro-mechanic components, a camera driver to control and allow access to an embedded image capture device, audio drivers to control and allow access to one or more audio devices.

The PMIC 3024 may manage power provided to various components of the device 3000. In particular, with respect to the processors 3004, the PMIC 3024 may control power-source selection, voltage scaling, battery charging, or DC-to-DC conversion.

A battery 3028 may power the device 3000, although in some examples the device 3000 may be mounted deployed in a fixed location and may have a power supply coupled to an electrical grid. The battery 3028 may be a lithium ion battery, a metal-air battery, such as a zinc-air battery, an aluminum-air battery, a lithium-air battery, and the like. In some implementations, such as in vehicle-based applications, the battery 3028 may be a typical lead-acid automotive battery.

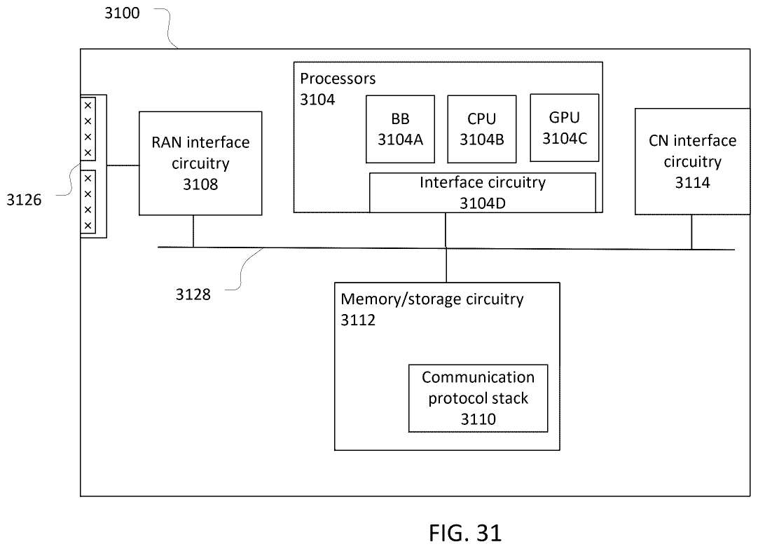

FIG. 31 illustrates a network device 3100 in accordance with some embodiments. The network device 3100 may be similar to, and substantially interchangeable with, base station 108.

The network device 3100 may include processors 3104, RF interface circuitry 3108 (if implemented as a base station), core network (CN) interface circuitry 3114, memory/storage circuitry 3112, and antenna structure 3126.

The components of the network device 3100 may be coupled with various other components over one or more interconnects 3128.

The processors 3104, RF interface circuitry 3108, memory/storage circuitry 3112 (including communication protocol stack 3110), antenna structure 3126, and interconnects 3128 may be similar to like-named elements shown and described with respect to FIG. 30.

The processors 3104 may include processor circuitry such as, for example, baseband processor circuitry (BB) 3104A, central processor unit circuitry (CPU) 3104B, and graphics processor unit circuitry (GPU) 3104C. The processors 3104 may include any type of circuitry or processor circuitry that executes or otherwise operates computer-executable instructions, such as program code, software modules, or functional processes from memory/storage circuitry 3112 to cause the network device 3100 to perform various operations for channel estimation, reference signal transmission, or RIS control as described herein. The processors 3104 may also include interface circuitry 3104D to communicatively couple the processor circuitry with one or more other components of the network device 3100.

The CN interface circuitry 3114 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 3100 via a fiber optic or wireless backhaul. The CN interface circuitry 3114 may include one or more dedicated processors or FPGAs to communicate using one or more of the aforementioned protocols. In some implementations, the CN interface circuitry 3114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes adjusting RIS phase shifters so that an original RS sequence sent from a transmitter and an effective RS sequence via RIS have a zero cross correlation zone.

Example 2 includes a procedure including: sending, by a transmitter, an RS sequence \tilde{s}₀ (in time domain); controlling a RIS to vary its phase shifters within transmission of s₀, so that the effective RS sequence over the cascaded RIS link becomes \tilde{s}₁, where \tilde{s}₀ and \tilde{s}₁ have a zero cross-correlation zone; and estimating, by a receiver, channels of the direct link and cascaded RIS link using \tilde{s}₀ and \tilde{s}₁ respectively. The RIS phase shifters may be switched between ϕᵢ and ϕᵢ+π for all i, where the additional phase shift π is either commonly applied to all RIS antenna elements or not.

Example 3 includes an original RS sequence s₀ is in the format of \tilde{s}₀=[0, x₀, x₁, 0, y₀, y₁], where x₀, x₁, y₀, and y₁ are Golay based sequences which satisfy the following two conditions: condition 1—both {x₀,x₁} and {y₀,y₁} are pair of Golay complementary sequences; and condition 2—the two Golay pairs are orthogonal with each other, for example, Cₓ_{₀}_{,y}_{₀}(n)+Cₓ_{₁}_{,y}_{₁}(n)=0, ∀n; C_{y}_{₀}_{,x}_{₀}(n)+C_{y}_{₁}_{,x}_{₁}(n)=0, ∀n, where Cₓ_{ᵢ}_{,y}_{ⱼ} denotes aperiodic correlation.

Example 4 includes constructing the sequences satisfying the conditions in example 3 by defining {x₀,x₁} as a pair of Golay complementary sequence, y₀=\tilde{x}₁ and y₁=−\tilde{x}₀ where \tilde{x}₁ denotes the reverse-ordered sequence.

Example 5, based on the sequence format given in example 3, switching RIS phase shifters as follows: RIS phase shifters are kept as ϕᵢ for all i when reflecting x₀ and y₀; RIS phase shifters are configured to be ϕᵢ+π for all i when reflecting x₁ and y₁. Hence, the effective sequences conveyed via RIS link becomes −x₁ and −y₁. When reflecting 0, RIS phase shifters can be either ϕᵢ or ϕᵢ+π for all i.

In example 6, the original RS sequence \tilde{s}₀ is in the format of \tilde{s}₀=[cpₛ_{₀}, s₀, cpₛ_{₀}, s₀], where cpₛ_{₀} is the CP for s₀ and s₀ is considered as the basic building block of the sequence. Then RIS varies its phase shifter so that effective RS for over RIS link becomes \tilde{s}₁=[cpₛ_{₀}, s₀, −cpₛ_{₀}, −s₀]

Example 7 may include selection of s₀ used in example 6, wherein in one example, s₀=[x₀, −x₁, x₀, x₁], where {x₀, x₁} is pair of Golay complementary sequences; and in another example, s₀=x₀, where x₀ is Zadoff-Chu sequence (or more generally chirp sequences).

In example 8, consider a scenario with Q RIS (so there are in total Q+1 links including the direct link) and U UEs, a Hadamard matrix W of size P(P>Q) may be generated and, for UE u, the time-domain RS sequence sent from UE u is

$${\tilde{s}}_{0}^{u} = 1 ⊗ {s}_{0}^{u} ,$$

where 1 is a row vector of size P and ⊗ denotes the Kronecker product; the phase shifters at the q-th RIS are adjusted so that the effective RS sequence over that link becomes

$${\tilde{s}}_{q}^{u} = W ( q + 1 , : ) ⊗ {\tilde{s}}_{0}^{u} ,$$

where W(q+1,:) is the (q+1)-th row of Hadamard matrix W for q=1, 2, . . . , Q.

Example 9 provides two alternatives of generating

$${s}_{0}^{u}$$

used in example 8. Alternative 1:

$${s}_{0}^{u} = U ( u , : ) ⊗ [ c {p}_{{s}_{0}} , {s}_{0} ] ,$$

where U(u,:) is the u-th row of a scaled unitary matrix (preferably with unit modulus entries) U with size U. Alternative 2:

$${s}_{0}^{u} = [ {cp}_{{\hat{s}}_{0}^{u}} , {\hat{s}}_{0}^{u} ]$$

and

$${\hat{s}}_{0}^{u}$$

is a cyclic shifted version of s₀. More specifically,

$${\hat{s}}_{0}^{u} [ l ] = {s}_{0} [ ( l + {C}_{u} ) mod L ] ,$$

where Cᵤ is the applied cyclic shift for UE u and L is the sequence length of s₀.

In example 10, a RIS controller configures and/or triggers RIS when to switch its phase shifters between ϕᵢ and ϕᵢ+π. In one alternative, RIS controller triggers RIS to switch its phase shifters (e.g., from ϕᵢ to ϕᵢ+π, or from ϕᵢ+π to ϕᵢ) after T1 seconds. In another alternative, RIS controller configures RIS to switch its phase shifter from ϕᵢ to ϕᵢ+π every T2 seconds, and from ϕᵢ+π to ϕᵢ every T3 seconds.

In example 11, the BS configures UE Q+1 different RS sequence resources for direct BS-UE link and Q cascaded BS-RIS-UE links, respectively. One sequence is the originally transmitted RS \tilde{s}₀ and the other ones are effectively generated from RIS phase shifter changes.

In example 12, the BS signals to UE to estimate the (Q+1)-port channel using the Q+1 sequences, respectively.

In example 13, in case of UE reporting for the Q+1 links, the reports are associated with the corresponding RS resource configurations.

Example 14 includes frequency modulation operated at RIS, so that the sent RS sequence over the direct link and the effective RS sequence over RIS link are orthogonal in frequency domain.

Example 15 includes a procedure comprising: sending, by a transmitter, RS sequence p₀ in frequency domain using comb manner; applying frequency modulation at RIS within transmission of p₀, so that the effective RS sequence over the cascaded RIS link becomes p₁; and estimating, at a receiver, the channels of the direct link and cascaded RIS link using p₀ and p₁ respectively, as p₀ and p₁ are orthogonal in frequency domain

Example 16 includes the BS configuring UE with one RS sequence and two different sets of RS frequency resources for direct BS-UE link and cascaded RIS link, respectively. One set of RS frequency resources contain one subband, and the other set of RS frequency resources contain another subband.

In example 17, the BS signals to UE to estimate the two-port channel using the RS on the two sets of frequency resources, respectively

Example 19 includes forming two simultaneous beams at the receiver side, where one of them points to transmitter while the other one points to RIS.

Example 20 includes a procedure comprising: sending, by a transmitter, and RS sequence; forming, by a receiver, two (narrow) beams simultaneously, so that one beam points to transmitter, while the other beam points to RIS; and estimating, by the receiver the channels of the direct link and cascaded RIS link using the two Rx beams respectively.

Example 21 includes forming the two simultaneous beams using a phase-time-array. In this way, the formed two beams are at two subbands pointing to different directions

In example 22, when using the architecture given in example 21, a receiver in one portion of time estimates one link on subband 1 and the other link on subband 2, and then in another portion of time estimates the one link on subband 2 and the other link on subband 1.

Example 23 includes a BS configuring a switching time t, which indicates how long UE should use subband 1 for channel estimation of one link and subband 2 for channel estimation of the other link; and then switch to subband 2 for channel estimation of the one link and subband 1 for channel estimation of the other link.

In example 24, the switching time t of example 23 can be in the format of, but not limited to, number of slots, (OFDM) symbols, or time samples.

In example 25, a group delay value is indicated to RIS. RIS applies the corresponding delay to the signals over RIS, so that the receiver is able to distinguish the channel estimates of the direct link and cascaded RIS link using different time windows

Example 26 includes a receiver channel estimation procedure as depicted in FIG. 26.

Example 27 includes a procedure of applying group delay at RIS as depicted in FIGS. 25 and 28.

In example 28, the BS configures the UE with one RS sequence and a group delay indication for the UE to distinguish and estimate channels for the direct link and cascaded RIS.

Example 29 includes a method comprising: detecting an initiation of a channel-estimation procedure associated with transmission of a reference signal (RS) sequence from a first device to a second device; and controlling a plurality of elements of a reconfigurable intelligent surface (RIS) to redirect the RS sequence to the second device with a code, frequency-domain, or time-domain transformation to enable direct and indirect channel estimations.

Example 30 includes the method of example 29 or some other example herein, wherein controlling the plurality of elements comprises: providing the plurality of elements in a first setting for redirecting a first segment of the RS sequence; and providing the plurality of elements of the RIS in a second setting for redirecting a second segment of the RS sequence.

Example 31 includes the method of example 30 or some other example herein, wherein a first element of the plurality of elements provides a first phase shift in the first setting and a second phase shift in a second setting, wherein a difference between the first phase shift and the second phase shift is 7E.

Example 32 includes the method of example 30 or some other example herein, wherein the plurality of elements of the RIS are to provide a first phase shift (ϕᵢ) in the first setting and a second phase shift (ϕᵢ+π) in the second setting, where i∈{1, 2, . . . , K} and K is a number of the plurality of elements.

Example 33 includes the method of example 30 or some other example herein, wherein the RS sequence provided to the BS over a direct link from the UE is a first sequence (\tilde{s}₀) and the RS sequence provided to the BS over an indirect link via the RIS is a second sequence (\tilde{s}₁), wherein a cross-correlation of the first sequence (\tilde{s}₀) and the second sequence (\tilde{s}₁) provides a zero-correlation zone that covers a path delay difference associated with the direct link and the indirect link. This cross correlation may be aperiodic cross correlation.

Example 34 includes the method of example 33 or some other example herein, wherein the first sequence comprises: a first pair of Golay complementary sequences; and a second pair of Golay complementary sequences.

Example 35 includes the method of example 34 or some other example herein, wherein the first pair of Golay complementary sequences are orthogonal with the second pair of Golay complementary sequences.

Example 36 includes the method of example 35 or some other example herein, wherein {x₀, x₁} is the first pair of Golay complementary sequences and {y₀, y₁} is the second pair of Golay complementary sequences.

Example 37 includes the method of example 36 or some other example herein, y₀=\tilde{x}₁ and y₁=−\tilde{x}₀, where \tilde{x}₁ is a reverse-ordered sequence of x₁ and \tilde{x}₀ is a reverse-ordered sequence of x₀.

Example 38 includes the method of example 36 or some other example herein, wherein the first sequence comprises a zero prefix and is in a format of [0, x₀, x₁, 0, y₀, y₁].

Example 39 includes the method of example 33 or some other example herein: wherein: \tilde{x}₀=[cpₛ_{₀}, s₀, cpₛ_{₀}, s₀]; and \tilde{x}₁=[cpₛ_{₀}, s₀, −cpₛ_{₀}, −s₀], where s₀ is the first segment, −s₀ is the second segment, and cpₛ_{₀} is a cyclic prefix for s₀.

Example 40 includes the method of example, wherein s₀=[x₀, −x₁, x₀, x₁], where {x₀, x₁} is a pair of Golay complementary sequences.

Example 41 includes a method of example 39 or some other example herein, wherein s₀=x₀, where x₀ is a chirp sequence.

Example 42 includes the method of example 30 or some other example herein, further comprising: configuring the RIS to switch between the first setting and the second setting after a predetermined period of time.

Example 43 includes a method of example 30 or some other example herein, further comprising: configuring the RIS to switch from the first setting to the second setting after a first predetermined period of time; and configuring the RIS to switch from the second setting to the first setting after a second predetermined period of time.

Example 44 includes a method of example 30 or some other example herein, wherein the first device is a user equipment and the second device is a base station.

Example 45 includes the method of example 30 or some other example herein, wherein the first device is a base station, the second device is a user equipment (UE), wherein the UE is configured with Q+1 different RS sequences resources for estimating channels over a direct link between the base station and the UE and over Q indirect links via Q RISs.

Example 46 includes a method comprising: receiving a signal; correlating a first segment of the signal with a reference signal (RS) sequence segment to obtain a first correlation result; correlating a second segment of the signal with the RS sequence segment to obtain a second correlation result; correlating the second segment of the signal with a phase-shifted version of the RS sequence segment to obtain a third correlation result; summing the first correlation result and the second correlation result to derive a first channel associated with a direct link; and summing the first correlation result and the third correlation result to derive a second channel associated with an indirect link.

Example 47 includes the method of example 46 or some other example herein, wherein a first RS sequence includes the RS sequence segment, a second RS sequence includes the phase-shifted version of the RS sequence segment, and a cross-correlation of the first RS sequence and the second RS sequence is zero or approximately zero. This cross-correlation may be periodic/cyclic cross correlation.

Example 48 includes the method of example 47 or some other example herein, wherein the RS sequence segment is s0, the phase-shifted version of the RS sequence segment is −s₀, the first RS sequence comprises [s₀, s₀], and the second RS sequence comprises [s₀, −s₀].

Example 49 includes the method of example 48 or some other example herein, further comprising: removing cyclic prefixes from the signal to obtain the first segment and the second segment.

Example 50 includes a method comprising: simultaneously forming a first receive beam pointed toward a transmitter to receive a reference signal (RS) sequence and a second receive beam pointed toward a reconfigurable intelligent surface (RIS) to receive the RS sequence; estimating a first channel associated with reception of the RS sequence using the first receive beam; and estimating a second channel associated with reception of the RS sequence using the second receive beam.

Example 51 includes the method of example 50 or some other example herein, further comprising: simultaneously forming the first receive beam and the second receive beam with a phase-time-array architecture, wherein the first receive beam is to be formed at a first subband and the second receive beam is to be formed at a second subband.

Example 52 includes the method of example 51 or some other example herein, further comprising: estimating the first channel in a first portion of time; and estimating the second channel in a second portion of time.

Example 53 includes the method of example 52 or some other example herein, further comprising: receiving, from a base station, a configuration of a switching time; and switching from the first portion of time to the second portion of time based on the configuration of the switching time.

Example 54 includes the method of example 53 or some other example herein, wherein the configuration of the switching time is an indication of a number of slots, symbols, or time samples.

Another example may include an apparatus comprising means to perform one or more elements of a method described in or related to any of examples 1-54, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-54, or any other method or process described herein.

Another example may include an apparatus comprising logic, modules, or circuitry to perform one or more elements of a method described in or related to any of examples 1-54, or any other method or process described herein.

Another example may include a method, technique, or process as described in or related to any of examples 1-54, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-54, or portions thereof.

Another example may include a signal as described in or related to any of examples 1-54, or portions or parts thereof.

Another example may include a datagram, information element, packet, frame, segment, PDU, or message as described in or related to any of examples 1-54, or portions or parts thereof, or otherwise described in the present disclosure.

Another example may include a signal encoded with data as described in or related to any of examples 1-54, or portions or parts thereof, or otherwise described in the present disclosure.

Another example may include a signal encoded with a datagram, IE, packet, frame, segment, PDU, or message as described in or related to any of examples 1-54, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-54, or portions thereof.

Another example may include a computer program comprising instructions, wherein execution of the program by a processing element is to cause the processing element to carry out the method, techniques, or process as described in or related to any of examples 1-54, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
detecting an initiation of a channel-estimation procedure associated with transmission of a reference signal (RS) sequence from a first device to a second device; and
controlling a plurality of elements of a reconfigurable intelligent surface (RIS) to redirect the RS sequence to the second device with a code, frequency-domain, or time-domain transformation to enable direct and indirect channel estimations.

2. The method of claim 1, wherein controlling the plurality of elements comprises:
providing the plurality of elements in a first setting for redirecting a first segment of the RS sequence; and
providing the plurality of elements of the RIS in a second setting for redirecting a second segment of the RS sequence.

3. The method of claim 2, wherein a first element of the plurality of elements provides a first phase shift in the first setting and a second phase shift in a second setting, wherein a difference between the first phase shift and the second phase shift is π.

4. The method of claim 2, wherein the plurality of elements of the RIS are to provide a first phase shift (ϕᵢ) in the first setting and a second phase shift (ϕᵢ+π) in the second setting, where i∈{1, 2, . . . , K} and K is a number of the plurality of elements.

5. The method of claim 2, wherein the RS sequence provided to the BS over a direct link from the UE is a first sequence (\tilde{s}₀) and the RS sequence provided to the BS over an indirect link via the RIS is a second sequence (\tilde{s}₁), wherein a cross-correlation of the first sequence (\tilde{s}₀) and the second sequence (\tilde{s}₁) provides a zero-correlation zone that covers a path delay difference associated with the direct link and the indirect link.

6. The method of claim 5, wherein the first sequence comprises:
a first pair of Golay complementary sequences; and
a second pair of Golay complementary sequences,
wherein:
the first pair of Golay complementary sequences are orthogonal with the second pair of Golay complementary sequences; and
{x₀, x₁} is the first pair of Golay complementary sequences and {y₀, y₁} is the second pair of Golay complementary sequences.

7. The method of claim 6, wherein:
y₀=x₁ and yᵢ=−\tilde{x}₀, where \tilde{x}₁ is a reverse-ordered sequence of x₁ and \tilde{x}₀ is a reverse-ordered sequence of x₀; or
the first sequence comprises a zero prefix and is in a format of [0, x₀, x₁, 0, y₀, y₁].

8. The method of claim 5, wherein:
\tilde{s}₀=[cpₛ_{₀}, s₀, cpₛ_{₀}, s₀]; and
\tilde{s}₁=[cpₛ_{₀}, s₀, −cpₛ_{₀}, −s₀], where s₀ is the first segment, −s₀ is the second segment, and cpₛ_{₀} is a cyclic prefix for s₀,
wherein:
0=[x₀, −x₁, x₀, x₁], where {x₀, x₁} is a pair of Golay complementary sequences; or
s₀=x₀, where x₀ is a chirp sequence.

9. The method of claim 2, further comprising:
configuring the RIS to switch between the first setting and the second setting after a predetermined period of time.

10. The method of claim 2, wherein the first device is a user equipment and the second device is a base station.

11. The method of claim 2, wherein the first device is a base station, the second device is a user equipment (UE), wherein the UE is configured with Q+1 different RS sequences resources for estimating channels over a direct link between the base station and the UE and over Q indirect links via Q RISs.

12. A method comprising:
receiving a signal;
correlating a first segment of the signal with a reference signal (RS) sequence segment to obtain a first correlation result;
correlating a second segment of the signal with the RS sequence segment to obtain a second correlation result;
correlating the second segment of the signal with a phase-shifted version of the RS sequence segment to obtain a third correlation result;
summing the first correlation result and the second correlation result to derive a first channel associated with a direct link; and
summing the first correlation result and the third correlation result to derive a second channel associated with an indirect link.

13. The method of claim 12, wherein a first RS sequence includes the RS sequence segment, a second RS sequence includes the phase-shifted version of the RS sequence segment, and a cross-correlation of the first RS sequence and the second RS sequence is zero or approximately zero.

14. The method of claim 13, wherein the RS sequence segment is s0, the phase-shifted version of the RS sequence segment is −s₀, the first RS sequence comprises [s₀, s₀], and the second RS sequence comprises [s₀, −s₀].

15. The method of claim 14, further comprising:
removing cyclic prefixes from the signal to obtain the first segment and the second segment.

16. One or more non-transitory, computer-readable media having instructions that, when executed, cause processing circuitry to:
simultaneously form a first receive beam pointed toward a transmitter to receive a reference signal (RS) sequence and a second receive beam pointed toward a reconfigurable intelligent surface (RIS) to receive the RS sequence;
estimate a first channel associated with reception of the RS sequence using the first receive beam; and
estimate a second channel associated with reception of the RS sequence using the second receive beam.

17. The one or more non-transitory, computer-readable media of claim 16, wherein the processing circuitry is to:
simultaneously form the first receive beam and the second receive beam with a phase-time-array architecture
wherein the first receive beam is to be formed at a first subband and the second receive beam is to be formed at a second subband.

18. The one or more non-transitory, computer-readable media of claim 17, wherein the processing circuitry is further to:
estimate the first channel in a first portion of time; and
estimate the second channel in a second portion of time.

19. The one or more non-transitory, computer-readable media of claim 18, wherein the processing circuitry is further to:
receive, from a base station, a configuration of a switching time; and
switch from the first portion of time to the second portion of time based on the configuration of the switching time.

20. The one or more non-transitory, computer-readable media of claim 19, wherein the configuration of the switching time is an indication of a number of slots, symbols, or time samples.
